(19) United States
(12) Patent Application Publication
(10) Pub. No.: US 2014/0293659 A1
(43) Pub. Date: Oct. 2, 2014

(54) HIGH-VOLTAGE GENERATING APPARATUS, HIGH-VOLTAGE POWER SUPPLY, AND IMAGE FORMING APPARATUS

(71) Applicant: OKI DATA CORPORATION, TOKYO (JP)

(72) Inventor: Toru KOSAKA, Tokyo (JP)

(73) Assignee: OKI DATA CORPORATION, TOKYO (JP)

(21) Appl. No.: 14/228,955

(22) Filed: Mar. 28, 2014

(30) Foreign Application Priority Data
Mar. 29, 2013 (JP) 2013-071849
Jun. 18, 2013 (JP) 2013-127125

(51) Int. Cl. H02M 3/335; G03G 15/00

(52) U.S. Cl. CPC H02M 3/33546; G03G 15/0283
USPC 363/21.09; 399/88

(57) ABSTRACT

A step-up transformer includes main, auxiliary, and secondary windings. The secondary winding steps up the voltage across the main winding. A rectifier rectifies the voltage across the secondary winding into a high-voltage output. A voltage converter produces a feedback signal from the high-voltage output, the feedback signal reflecting the magnitude of the high-voltage output. An integrator receives the feedback signal and a reference signal indicative of a target high-voltage output. A DC power supply supplies drain current into a field effect transistor (FET). The auxiliary winding has one end that receives the output of the integrator and the other end that outputs an AC voltage to a differentiator. The differentiator has a resistor connected between the gate of the FET and the ground, and a parallel circuit of a resistor and a capacitor, the parallel circuit connecting between the auxiliary winding and the gate of the FET.

### BACKGROUND OF THE INVENTION

1. Field of the Invention

This invention relates to a high-voltage power supply and an image forming apparatus that incorporates the high-voltage power supply.

2. Description of the Related Art

Among known high-voltage power supplies is one disclosed in Japanese Patent Publication No. H11-341801. The PWM signal of a microcomputer is fed to the base of a bipolar transistor through a main winding of a step-up transformer. A DC voltage is fed to the collector of the bipolar transistor through the main winding of the step-up transformer. The secondary winding is connected to a load through a rectifying circuit. The DC output voltage of the rectifying circuit is fed back to the microcomputer. In this manner, the DC high-voltage output voltage is controlled.

FIG. 41 illustrates a specific example of the high-voltage power supply according to the publication No. H11-341801. The PWM output terminal 790c of a microcomputer 701 is connected to a 3.3 V power supply 702 through a pull-up resistor 707. The PWM output terminal 790c is also connected to a filter circuit 710 formed of a resistor 711 and a capacitor 712. The output of the filter circuit 710 is fed to an inverting input (−) of an operational amplifier (OP amp) 721.

An integrator 720 is formed of the OP amp 721, capacitors 722 and 725, and resistors 723, 724, and 726, and provides its output to one end of an auxiliary winding 751 on the primary side of a step-up transformer 750. Another end of the auxiliary winding 751 is connected to the base of an NPN transistor 740.

A main winding 752 of the step-up transformer 750 has one end connected to a 24 V power source 703 and the other end connected to the collector of the NPN transistor 740. The output of the secondary winding 753 of the step-up transformer 750 is rectified by a rectifying circuit 760, and the output of the rectifying circuit 760 is supplied as a high-voltage output to a load 785.

A portion of the high-voltage output at the node 790A is fed back to the non-inverting input (+) of the OP amp 721 through an output voltage converter 770 that performs conversion of output voltage (i.e., voltage step-down) to produce a feedback voltage. The rectifying circuit 760 includes diodes 761 and 762 and capacitors 763 and 764. The output voltage converter 770 includes a 50 MΩ resistor 771, a 100 kΩ resistor 772, a 1 MΩ pull-down resistor 773, and a capacitor 774.

In the initial state, the microcomputer 701 outputs a High level PWM signal. This output is held to the output voltage of the power supply 702 by a pull-up resistor 707, so that a voltage of 3.3 V is fed to the inverting input (−) of the OP amp 721 through the filter circuit 710. At this point of time, the high-voltage output does not appear at a node 790A yet, and the 3.3 V output voltage of the power supply 702 is divided by the 100 kΩ resistor 771 and the 1 MΩ resistor 773, so that a voltage of 3.0 V appears across the resistor 773. This voltage is then fed to the non-inverting input (+) of the OP amp 721.

The voltage (=3.0 V) fed to the non-inverting input (+) is lower than the voltage (3.3 V) on the inverting input, so the output of the OP amp 721 is at its lowest voltage (VOL≠0 V). Therefore, no base current flows through the NPN transistor 740 so that no current flows through the main winding 752. As a result, the node 790A is maintained at its OFF state.

Subsequently, the microcomputer 701 initiates outputting the PWM signal with a duty cycle corresponding to the target high-voltage output, the PWM signal being fed to the inverting input (−) through the filter circuit 710. The higher the target high-voltage output is, the smaller the duty cycle of the PWM signal is. Therefore, the voltage fed to the inverting input (−) of the OP amp is low.

When the voltage at the inverting input (−) becomes lower than that at the non-inverting input (+), the output of the integrator 720 starts to gradually increase. As a result, current flows into the base of the transistor 740 from the auxiliary winding 751 of the step-up transformer 750, so current flows from the 24 V power supply 703 via the main winding 752 through the collector-emitter junction of the transistor 740. The current through the main winding 752 causes the base potential connected to the auxiliary winding 751 to decrease, shutting off the current flowing through the primary winding 752. The currents through the primary winding 752 and the auxiliary winding 751 alternate between the ON state and the OFF state, hence self-oscillation.

In this manner, the alternation of the ON and OFF states of the current through the main winding 752 causes an AC output having a stepped-up voltage to appear across the secondary winding 753. The voltage across the secondary winding 753 is rectified by a rectifying circuit 760, so that a negative high-voltage output appears on the node 790A and is supplied to the load 785.

The output of the rectifying circuit 760 or the output on the node 790A is divided down by an output voltage converter 770 and is fed back to the non-inverting input (+) of the OP amp 721. Since the high-voltage output on the node 790A is negative, the larger the absolute value of the high-voltage output on the node 790A becomes, the smaller absolute value of the voltage fed back to the non-inverting input (+) is.

The base current of the transistor 740 varies in accordance with the difference between the voltage at the inverting input of the OP amp 721 and the voltage at the non-inverting input. The base current is then amplified to yield a larger collector current, which is proportional to the base current and flows through the transistor 740. As a result, the high-voltage output, stepped up due to self-oscillation, is maintained at a value in accordance with the duty cycle of the PWM signal.

FIG. 42 illustrates an example of the waveform of the output of the circuit shown in FIG. 41 when the circuit starts to output the high-voltage output. References D790A-D790D denote the changes in potential at the nodes 790A-790D (FIG. 41), respectively. References D790A0-D790D0 denote the zero levels of the waveforms D790A-D790D, respectively.

The PWM signal is maintained at the High level before the circuit starts to output the high-voltage output. The duty cycle of the PWM signal is then switched to a value corresponding to the target high-voltage output of −1500 V at time T11. The high-voltage output at the node 790A reaches 90% of −1500 V at time T12. The period of time from T11 to T12 is called a startup time and is 10.6 ms.

FIG. 43 illustrates an example of a circuit formed by combining circuits similar to that of FIG. 41. The circuit selectively generates positive and negative high-voltage outputs. The circuit includes a positive bias circuit 810 that receives the PWMp signal with a duty cycle corresponding to a target positive high-voltage output, and a negative bias circuit 820 that receives the PWMn signal with a duty cycle corresponding to a target negative high-voltage output.

The positive bias circuit 810 includes a transformer driver circuit 830, a step-up transformer 835, a rectifying circuit 840, and resistors 857-859. The rectifying circuit 840 includes diodes 843 and 844 and capacitors 845 and 846. The step-up transformer 835, rectifying circuit 840, and resistors 857 and 858 constitute a step-up mold transformer 837.

The negative bias circuit 820 includes a transformer driver circuit 860, a step-up transformer 865, a rectifying circuit 870, a frequency adjusting capacitor 882, and resistors 887-889. The rectifying circuit 870 includes diodes 873 and 874 and capacitors 875 and 876. The transformer driver circuits 830 and 860 are configured just as in the transformer driver circuit 705 shown in FIG. 41, and includes a transistor similar to the transistor 740.

The negative high-voltage output is applied to a load 890 through the resistor 858, e.g., 100 MΩ. The negative high-voltage output is divided by the resistors 887-889 and is fed back to the transformer driver circuit 860, so that the negative high-voltage output is feedback-controlled. The resistors 887-889 are, for example, 5 MΩ, 1 MΩ, and 5 kΩ, respectively.

The positive output current is supplied to a load 890 through the resistors 887 and 889. The voltage divided by the resistors 857 and 859 is fed back to the transformer driver circuit 830.

The above-described conventional apparatus fails to supply sufficiently large current when the negative high-voltage output is applied to the load. For example, assume that the step-up transformer 865 is an open type transformer (non-mold transformer) that employs an EE16 size ferrite core. Also assume that the transistor is an NPN transistor with Pc=25 W, is in the TO-220 package, and serves to play the same role as the transistor 740 (FIG. 41) in the transfer driver circuit 860. Thus, the rectifying circuit 870 is only capable of outputting a current of 570 μA at −2700 V. This implies that the current only in the range of 25 to 14 μA will flow into the load 890 having a resistance in the range of 10 to 100 MΩ.

When the positive high-voltage output is outputted, the current is supplied through the 5 MΩ resistor 887. If a current of 600 μA is to be supplied to the load 890, the voltage drop across the resistor 887 is 3000 V. If a current larger than 600 μA is supplied to the load, the potential difference between traces formed on the circuit board exceeds 3000 V, causing an electrical discharge between the traces.

Decreasing the resistance of the feedback resistor 887 would improve the ability of the high-voltage power supply to supply the positive high-voltage output, but impair the ability to supply the negative high-voltage output. In recent years, there have been demands in the field of intermediate transfer image forming apparatus towards the capability of printing on a variety of types of print media. For print media having narrower widths such as post cards and visiting cards, most of the transfer current will flow directly from the transfer rollers to the intermediate transfer belt, necessitating that larger current flows when printing is performed on a high resistance medium such a film. Conventional high-voltage power supplies fail to supply such large currents.

In addition, if the secondary transfer nip is brought closer to a fixing unit in an attempt to print on a print medium having a short length in the direction of travel, the heat generated by the fixing unit will increase the temperature of the transfer roller, causing the resistance of the transfer roller to decrease, hence increased transfer current. For this reason, the second transfer nip could not be positioned close to the fixing unit.

### SUMMARY OF THE INVENTION

An object of the invention is to provide a high-voltage power supply capable of supplying large current without an electric discharge between traces formed on the circuit board.

A high-voltage power supply supplies a high-voltage output to a load.

A transformer includes a main winding with a first end connected to a DC power supply and a second end, an auxiliary winding with a third end and a fourth end, and a secondary winging that steps up a voltage developed across the main winding. A rectifier rectifies the stepped up voltage into a high-voltage output. A voltage converter produces a feedback signal from the high-voltage output, the feedback signal reflecting the high-voltage output. A field effect transistor includes a drain connected to the second end, a gate, and a source connected to the ground through either a resistor or direct connection. A differentiator includes a parallel circuit of a second resistor and a capacitor, and a third resistor connected between a fifth end of the parallel circuit and the ground, the fifth end being connected to the gate of the field effect transistor, the sixth end being connected to the fourth end of the auxiliary winding so that a voltage appearing across the auxiliary winding is fed through the capacitor to the gate of the field effect transistor, causing self-oscillation. An integrator includes an operational amplifier with a first input terminal to which a reference signal indicative of a target high-voltage output is inputted, a second input terminal to which the feedback signal is inputted, and an output terminal, the integrator integrating the difference between the reference signal and the feedback signal and feeding the integrated output to the third end from the output terminal, so that negative feedback is performed to maintain the high-voltage output to the target high-voltage output.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates an image forming apparatus according to a first embodiment;

FIG. 2 shows the control system for the image forming apparatus shown in FIG. 1;

FIG. 3 is a block diagram illustrating a print engine controller and a high-voltage power supply shown in FIG. 2;

FIGS. 4 and 5 illustrate a charging voltage generating section of the high-voltage power supply;

FIGS. 6A and 6B illustrate the outline of a step-up transformer shown in FIG. 5;

FIG. 7 illustrates the waveforms at various parts of the circuit when the high-voltage output is −1500 V;

FIGS. 8 and 9 illustrate the waveforms at various parts of the circuit when the charging voltage generating section starts toward a target high-voltage output of −650 V shortly after the print engine controller outputs serial data indicative of 8Chex to a D/A converter;

FIG. 10 illustrates the outline of the waveforms of the gate voltage D390B and drain current D390D;

FIG. 11 illustrates the waveforms, similar to those shown in FIG. 9, when a Zener diode is not inserted in the circuit shown in FIG. 5;

FIG. 12 illustrates the outline of the waveforms of the gate voltage D390B and drain current D390D shown in FIG. 11 of a high-voltage power supply according to a second embodiment;

FIG. 13 illustrates the relationship between the gate-to-source voltage Vgs and drain current Id of the FET 340;

FIG. 14 is the schematic diagram of the high-voltage power supply shown in FIG. 13;

FIG. 15 illustrates the operation of the circuit shown in FIGS. 13 and 14 when the high-voltage power supply starts up;

FIGS. 16-19 illustrate the waveforms when the high-voltage power supply starts up toward the target high-voltage output;

FIG. 20 illustrates a secondary transfer voltage generating section of the high-voltage power supply;

FIG. 21 illustrates the entire negative bias generator;

FIG. 22 illustrates the entire positive bias generator;

FIGS. 23A and 23B illustrate the outline of a step-up transformer shown in FIG. 21;

FIGS. 24A-24C illustrate a core used for the step-up transformer;

FIG. 25 illustrates the waveforms of the voltages and currents appearing at various parts of the circuit when the negative bias generator shown in FIG. 21 outputs the high-voltage output;

FIG. 26 illustrates the outline of the waveforms of the gate voltage D390B and drain current D390D;

FIG. 27 illustrates the waveforms, similar to those shown in FIG. 25, when the Zener diode is not inserted in the circuit shown in FIG. 21;

FIG. 28 illustrates the outline of the waveforms of the gate voltage D390B and drain current D390D shown in FIG. 27;

FIG. 29 illustrates the relationship between the gate-to-source voltage Vgs and drain current Id of the FET;

FIG. 30A illustrates the waveforms at various points in the circuit when a 0.01 μF capacitor is inserted into the circuit;

FIG. 30B illustrates the comparison waveforms at various points in the circuit when the 0.01 μF capacitor is not inserted into the circuit;

FIG. 31 illustrates a transformer driver circuit and a step-up transformer for a negative bias generator according to a fourth embodiment;

FIG. 32 illustrates a transformer driver and a step-up transformer for a negative bias generator according to a fifth embodiment;

FIG. 33 illustrates a transformer driver circuit and a step-up transformer for a negative bias generator according to a sixth embodiment;

FIG. 34 is the block diagram of a negative bias generator, corresponding to FIG. 33, together with a 3.3 V power supply and a 24 V DC power supply;

FIG. 35 illustrates a transformer driver circuit and a step-up transformer for a negative bias generator according to a seventh embodiment;

FIG. 36 illustrates a transformer driver circuit and a step-up transformer for a negative bias generator according to an eighth embodiment;

FIG. 37 illustrates the relationship among temperature, resistance of thermistor, and clamp voltage;

FIG. 38 is a graph illustrating the relationship between the resistance of the thermistor and temperature;

FIGS. 39A-39C illustrate examples of the mounting location of the thermistor;

FIG. 40 illustrates the relationship between the gate-to-source voltage Vgs and the drain current Id of the FET;

FIG. 41 illustrates a specific example of a high-voltage power supply according to the publication No. H11-341801;

FIG. 42 illustrates an example of the waveform of the output of the circuit shown in FIG. 41 when the circuit starts to output the high-voltage output; and

FIG. 43 illustrates an example of a circuit formed by combining circuits similar to that of FIG. 41.

### DETAILED DESCRIPTION OF THE INVENTION

### First Embodiment

### {Image Forming Apparatus}

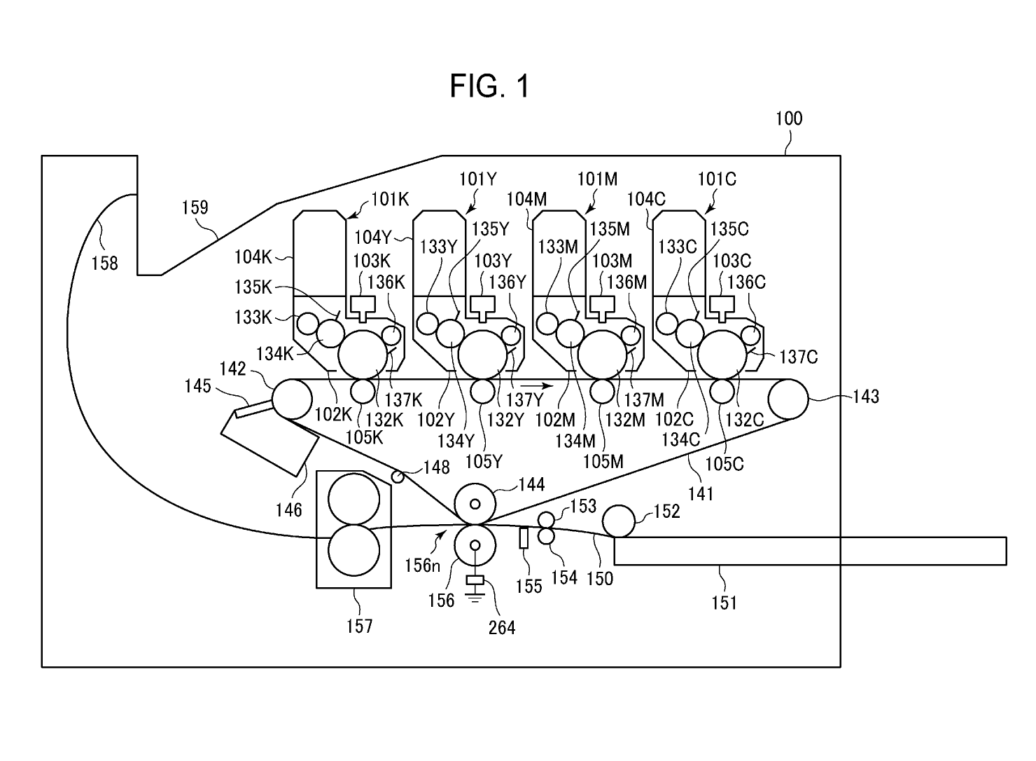

FIG. 1 illustrates an image forming apparatus 100 according to a first embodiment. The image forming apparatus 100 is configured to perform a primary transfer function and a secondary transfer function. The primary transfer function is performed in the order of black, yellow, magenta, and cyan images. The image forming apparatus 100 includes image forming units 101K (back), 101Y (yellow), 101M (magenta), and 101C (cyan).

The black image forming unit 101K includes a developing section 102K, and an LED head 103K, a toner reservoir 104K, and a primary roller 105K. The developing section 102K includes a photoconductive drum 132K, a charging roller 136K, a developing roller 134K, a supplying 133K, a developing blade 137K, and a cleaning blade 137K. The transfer roller 105K is positioned to parallel the photoconductive drum 132K.

Likewise, the yellow image forming unit 101Y includes a developing section 102Y, and an LED head 103Y, a toner reservoir 104Y and a primary roller 105Y. The developing section 102Y includes a photoconductive drum 132Y, a charging roller 136Y, a developing roller 134Y, a supplying roller 133Y, a developing blade 137Y, and a cleaning blade 137Y. The transfer roller 105Y extends in parallel to the photoconductive drum 132Y.

Likewise, the magenta image forming unit 101M includes a developing section 102M, and an LED head 103M, a toner reservoir 104M and a primary roller 105M. The developing section 102M includes a photoconductive drum 132M, a charging roller 136M, a developing roller 134M, a supplying roller 133M, a developing blade 137M, and a cleaning blade 137M. The transfer roller 105M extends in parallel to the photoconductive drum 132M.

Likewise, the cyan image forming unit 101C includes a developing section 102C, and an LED head 103C, a toner reservoir 104C and a primary roller 105C. The developing section 102C includes a photoconductive drum 132C, a charging roller 136C, a developing roller 134C, a supplying roller 133C, a developing blade 137C, and a cleaning blade 137C. The transfer roller 105C extends in parallel to the photoconductive drum 132C.

The image forming apparatus 100 further includes an intermediate transfer belt 141, a driven roller 142, a drive roller 143, a back-up roller 144, a tension roller 148, a belt cleaning blade 145, a waste toner container 146, a paper cassette 151, a hopping roller 152, a pair of registration rollers 153 and 154, a paper detecting sensor 155, a secondary transfer roller 156, a fixing unit 57, a guide 158, and a stacker 159. The paper cassette 151 holds a stack of print paper 150. The secondary transfer roller 156 may be configured such that the secondary transfer roller 156 is moved into and out of contact with the intermediate transfer belt 141.

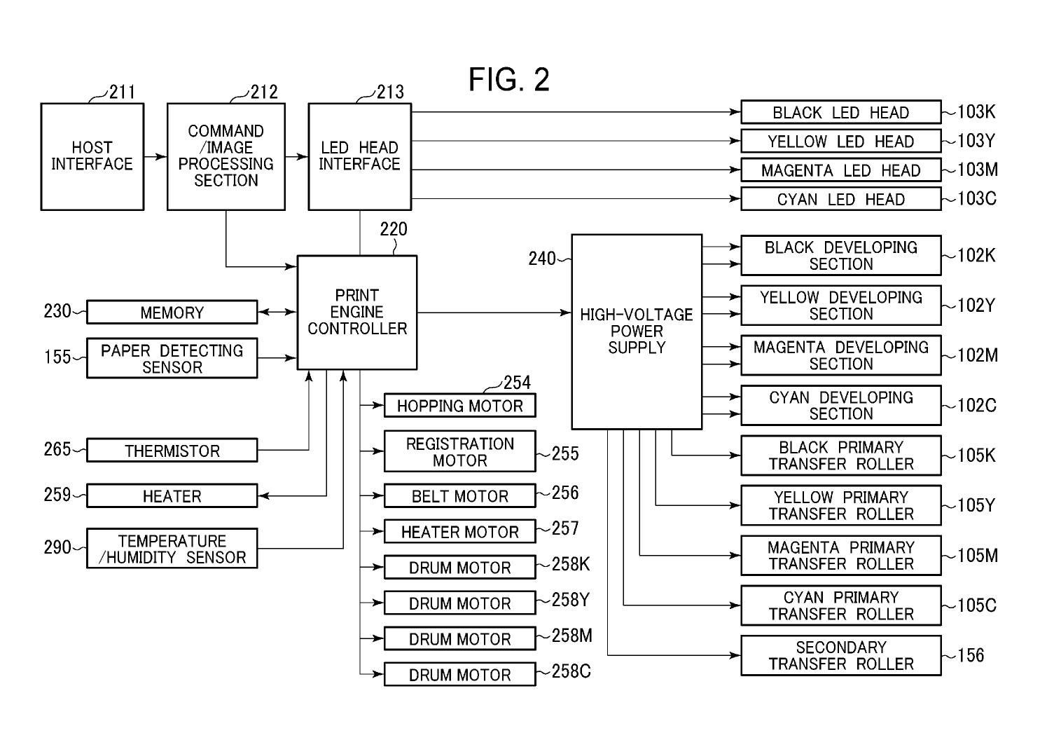

FIG. 2 shows the control system for the image forming apparatus shown in FIG. 1 together with associated structural elements and sensors. Elements similar to those in FIG. 1 have been given the same reference numerals. The system shown in FIG. 2 includes a host interface 211, a command/image processing section 212, an LED head interface 213, a print engine controller 220, a memory 230, and a high-voltage power supply 240.

Connected to the print engine controller 220 are the paper detecting sensor 155, a thermistor 265, a heater 259, a temperature/humidity sensor 290, a hopping motor 254, a registration motor 255, a belt motor 256, heater motor 257, and drum motors 258K, 258Y, 258M, and 258C. The thermistor 265 detects the temperature of the heater 259, and outputs a signal indicative of the detected temperature.

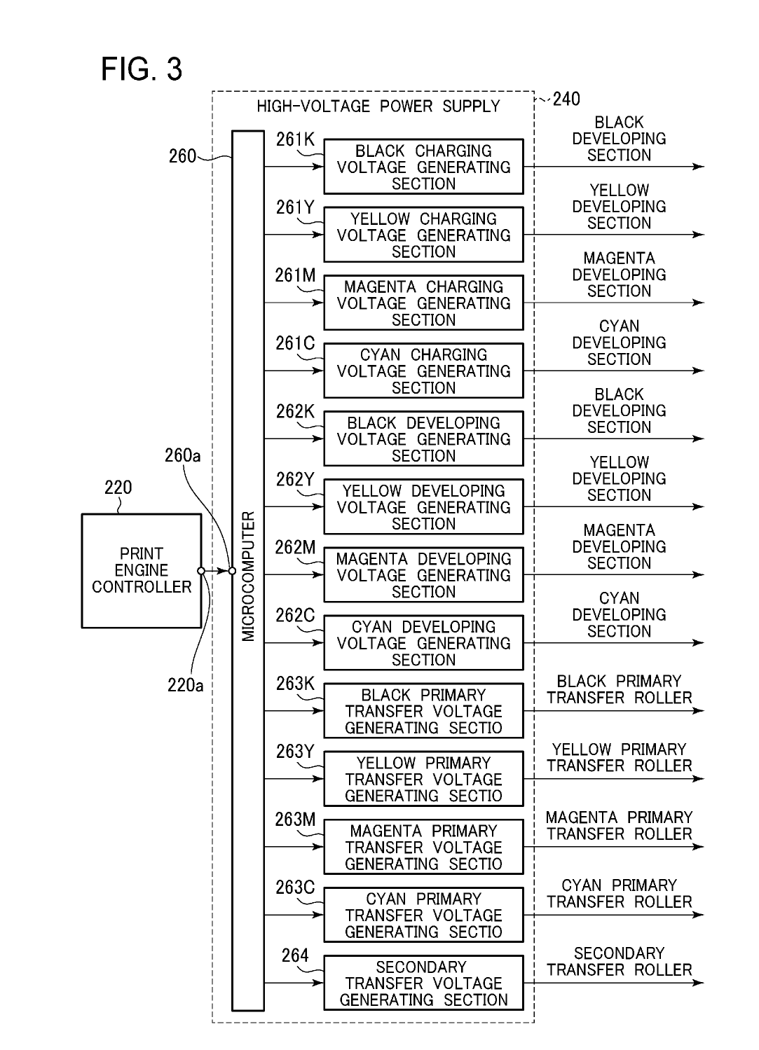

FIG. 3 is a block diagram illustrating the print engine controller and the high-voltage power supply shown in FIG. 2. Referring to FIG. 3, the high-voltage power supply 240 includes a microcomputer 260 as a settings outputting section, charging voltage generating sections 261K, 261Y, 261M, and 261C, primary transfer voltage generating sections 263K, 263Y, 263M, and 263C, and a secondary transfer voltage generating section 264.

The image forming apparatus 100 receives print data, which is written in a page description language (PDL), from external equipment (not shown) through the host interface 211. The received print data is rendered by the command/image processing section 212 into bit map data. The print engine controller 220 controls the heater 259 in accordance with the signal indicative of the temperature received from the thermistor 265, thereby maintaining the fixing unit 157 to a predetermined temperature. The image forming apparatus then starts printing by electrophotography.

The hopping roller 152 feeds the print paper 150 from the paper cassette 151 shown in FIG. 1. The print paper 150 is transported by the registration rollers 153 and 154 to a nip 156N formed between the intermediate transfer belt 141 and the secondary back-up roller 144.

The toner reservoirs 104K, 104Y, 104M, and 104C are detachably attached to the developing sections 102K, 102Y, 102M, and 102C, respectively, and supply the toner therein to the corresponding developing units.

In the electrophotography process, the charging voltage generating sections 261K, 261Y, 261M, and 261C supply the charging voltages to the developing sections 102K, 102Y, 102M, and 102C, respectively, thereby charging the photoconductive drums 132K, 132Y, 132M, 132C, respectively.

Subsequently, the light emitting elements of the LED heads 103K, 103Y, 103M, and 103C are selectively energized to illuminate the charged surfaces of the photoconductive drums 132K, 132Y, 132M, and 132C, respectively, to dissipate the charges on the surfaces, thereby forming electrostatic latent images on the photoconductive drums 132K, 132Y, 132M, and 132C. The electrostatic latent images are then developed with the toner into toner images. During the developing operation, developing voltage generating sections 262K, 262Y, 262M, and 262C supply developing voltages to the developing sections 102K, 102Y, 102, and 102C, respectively.

The toner images on the photoconductive drums, developed by the developing sections 102K, 102Y, 102M, and 102C, are transferred sequentially in registration onto the intermediate transfer belt 141 with the aid of the high-voltage output applied to the transfer rollers 105K, 105Y, 105M, and 105C. For this purpose, the primary transfer voltage generating sections 263K, 263Y, 263M, and 263C supply primary transfer bias voltages to the transfer rollers 105K, 105Y, 105M, and 105C, respectively. Thus, the toner images of four colors are transferred onto the intermediate transfer belt 141 in sequence.

The secondary transfer roller 156 may be configured such that a solenoid 299 is energized to bring the secondary transfer roller into contact with the intermediate transfer belt 141, and de-energized to bring the secondary transfer roller out of contact with the intermediate transfer belt 141.

In timed relation to the arrival of the toner images on the intermediate belt 141 at the nip 156N, the print paper 150 is transported to the nip 156N.

While the print paper 150 is passing through the nip 156N, the secondary transfer roller 156 receives the secondary transfer voltage, and transfers at a time the toner images of four colors on the intermediate transfer belt 141 onto the print paper 150.

For performing the secondary transfer function, the secondary transfer voltage generating section 264 supplies a secondary positive transfer bias voltage to the secondary transfer roller 156. More specifically, the secondary transfer voltage generating section 264 starts to supply the secondary positive transfer bias voltage to the secondary transfer roller 156 as soon as the leading edge of the print paper 150 arrives at the nip 156N, and then terminates supplying a secondary transfer bias voltage immediately before the trailing edge of the print paper 150 leaves the nip 156N. When the secondary transfer voltage is not to be applied to the secondary transfer roller 156, the secondary transfer voltage generating section 264 supplies a negative high-voltage output to the secondary transfer roller 156, thereby preventing the secondary transfer roller 156 from being contaminated by the toner remaining on the intermediate transfer belt 141.

As shown diagrammatically in FIG. 1, the secondary transfer voltage generating section 264 is connected to the secondary transfer roller 156 to supply the high-voltage output to the secondary transfer roller 156. The charging voltage generating sections 261K-261C, developing voltage generating sections 262K-262C, and primary transfer voltage generating sections 263K-263C are also connected to their corresponding loads, though not shown in FIG. 1.

The toner images on the print paper 150 is fixed by the fixing unit 157, and then the print paper 150 is discharged onto the stacker 159.

The print engine controller 220 sets the target high-voltage outputs according to predetermined values in a table, and commands at predetermined timings to the charging voltage generating sections 261K-261C, developing voltage generating sections 262K-262C, primary transfer voltage generating sections 263K-263C, and the secondary transfer voltage generating section 264, instructing to output the corresponding target high-voltage outputs.

### {Charging Voltage Generating Section}

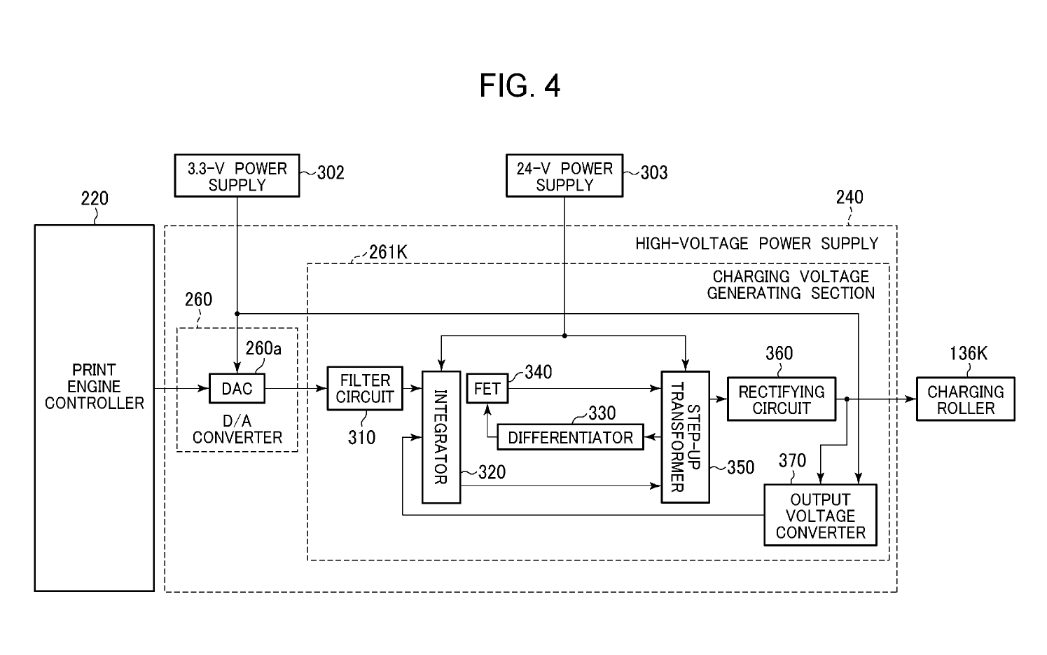

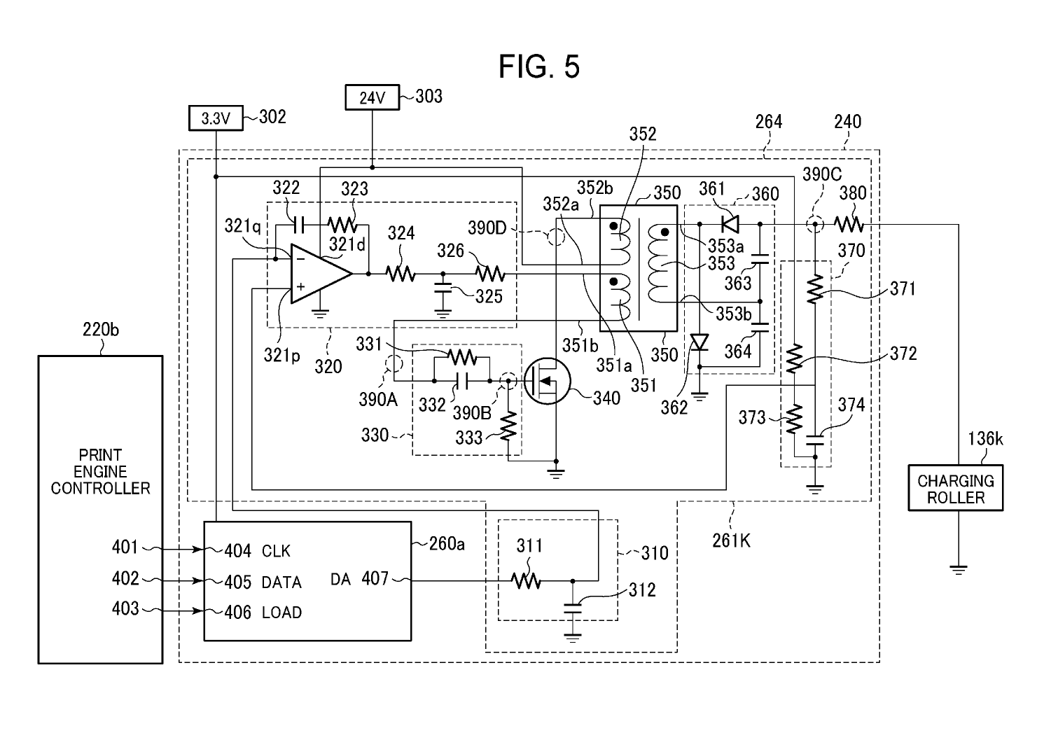

FIGS. 4 and 5 illustrate the charging voltage generating section 261K of the high-voltage power supply 240 together with the print engine controller 220 and power supplies 302 and 303. Other voltage generating sections 261Y, 261M, and 261C, and 262K, 262Y, 262M, and 262C, and 263K, 263Y, 263M, and 263C are configured similarly. The charging voltage generating section 261K generates a negative high-voltage output.

The print engine controller 220 outputs a sync clock, serial data, and a load signal from a clock output port 401, a data output port 402, and a load signal output port 403, respectively.

The power supply 302 is a 3.3 V DC power supply, and is connected to the microcomputer 260 and the charging voltage generating section 261K. The power supply 303 is a 24 V DC power supply, and is connected to the charging voltage generating section 261K.

The microcomputer 260 (FIG. 3) includes, for example, a digital-to-analog (D/A) converter 260a. The D/A converter 260a includes a CLK sync clock input port 404, a serial DATA input port 405, and a load signal input port 406. These ports receive the sync clock, serial data, and load signal from the clock output port 401, data output port 402, and load signal output port 403, respectively. The serial data takes the form of 8-bit data. The serial data has a value of FFhex when a reference voltage of 3.3 V is to be outputted, and a value of 00hex when a reference voltage of 0 V is to be outputted.

The serial data is outputted from the data output port 402 in synchronism with the sync clock outputted from the clock output port 401. Shortly after outputting all the bits (e.g., 8 bits), the load signal is outputted from the load signal output port 403. Upon reception of the load signal, the D/A converter 260a captures the entire serial data and outputs an analog voltage signal corresponding to the serial data from a D/A output port 407.

The charging voltage generating section 261K includes a filter circuit 310, an integrator 320, a differentiator 330, an enhancement type N-channel field effect transistor (FET) 340, a step-up transformer 350, a rectifying circuit 360, and an output voltage converter 370.

The filter circuit 310 includes a resistor 311 and a capacitor 312. The D/A converter 260a outputs the analog voltage signal from the D/A output port 407 to the filter circuit 310, which in turn outputs a DC voltage to the integrator 320.

The integrator 320 includes an operational amplifier (OP amp) 321, capacitors 322 and 325, resistors 323, 324, and 326. The output of the integrator 320 is fed to one end 351a of an auxiliary winding 351 of the step-up transformer 350, and the other end 351b of the auxiliary winding 351 is connected to the gate of the MOS FET 340.

The differentiator 330 includes resistors 331 and 333 and a capacitor 332. The resistor 331 is in parallel with the capacitor 332.

The main winding 352 of the step-up transformer 350 has one end 352a connected to the 24 V power supply 303 and the other end 352b connected to the drain of the FET 340.

The output of the secondary winding 353 of the step-up transformer 350 is rectified by the rectifying circuit 360. The rectifying circuit 360 includes a series circuit of diodes 361 and 362 and a series circuit of capacitors 363 and 364, these two series circuits being connected in parallel with each other. The junction point of the diodes 361 and 362 is connected to one end 353a of the secondary winding 353, and the junction point of the capacitors 363 and 364 is connected to the other end 353b of the secondary winding 353. The rectifying circuit 360 full-wave rectifies the output of the secondary winding 353. The cathode of the diode 362 serves as a positive output terminal and the anode of the diode 361 serves as a negative output terminal. The negative output of the rectifying circuit 360 is supplied to a load or the charging roller 136K through the resistor 380.

A portion of the high-voltage output at the node 390C is fed back to the non-inverting input 321p of the OP amp 321. The output voltage converter 370 includes a 50 MΩ resistor 371, a 100 kΩ resistor 372, a 1 MΩ pull-down resistor 373, and a capacitor 374.

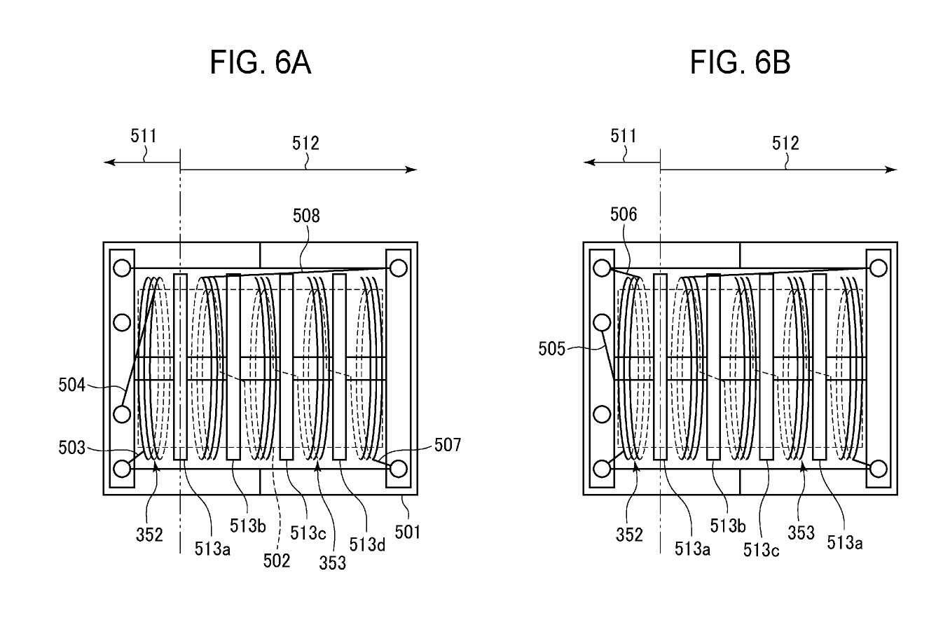

FIGS. 6A and 6B illustrate the outline of the step-up transformer 350 shown in FIG. 5. The step-up transformer 350 has a primary side 511 and a secondary side 512. The main winding 351, auxiliary winding 352, and secondary winding 353, are wound on a bobbin 502 (dotted lines) into which an EE16 ferrite core 501 extends. The auxiliary winding 351 is wound on the bobbin 502 on the primary side as shown in FIG. 6A, and the main winding 352 is wound over the auxiliary winding 351 as shown in FIG. 6B.

The auxiliary winding 351 has a start end 503 and a finish end 504, the main winding 352 has a start end 505 and a finish end 506. The secondary winding 353 has a start end 507 and a finish end 508.

When the high-voltage power supply 240 starts to operate, the print engine controller 220 sets the output voltage of the D/A converter 260a to 3.3 V as follows: The print engine controller 220 outputs the serial data (e.g., FFhex) indicative of 3.3 V from the data output port 402 in synchronism with the clock outputted from the clock output port 401. Shortly after all the bits of the serial data have been outputted, the print engine controller 220 outputs the load signal so that the D/A converter 260a captures all the bits. As a result, the D/A converter 260a outputs an analog voltage of 3.3 V from the D/A output port 407. The 3.3 V analog voltage is then fed to an inverting input 321q of the OP amp 321 through the filter circuit 310.

When the high-voltage output is not to be outputted on the node 390C, the 3.3 V analog voltage is divided by the resistors 372 (100 kΩ) and 373 (1 MΩ) of the output voltage converter 370, and the resultant 3.0 V is fed as a feedback voltage to the non-inverting input 321p of the OP amp 321. The feedback voltage reflects the voltage of the high-voltage output.

Since the 3.3 V voltage at the inverting input 321q is higher than the 3.0 V voltage at the non-inverting input 321p, the output voltage VO of the OP amp 321 is lowest (VOL is nearly equal to 0 V).

At this moment, the gate voltage VG of the FET 340 is sufficiently lower than the gate threshold voltage VTH. Thus, the FET 340 remains in the OFF state so that no current flows through the main winding 352 and therefore the high-voltage output does not appear on the node 390C.

When printing is started, the print engine controller 220 drives the drum motor 258K to rotate the photoconductive drum 132K, and drives the charging voltage generating section 261K to output the negative high-voltage output to the charging roller 136K. Other charging voltage generating sections also apply their negative high-voltage output to the corresponding charging rollers.

For applying the negative high-voltage output to the charging roller 136K, the print engine controller 220 supplies the data indicative of the target high-voltage output to the D/A converter 260a through serial communication. The D/A converter 260a switches its output voltage from 3.3 V to the voltage corresponding to the target high-voltage output.

The target high-voltage output is, for example, −1500 V, in which case the print engine controller 220 outputs serial data describing 15hex from the data output port 402. The D/A converter 260a captures the serial data upon the load signal outputted from the load signal output port 403, and then outputs a voltage of 0.272 V corresponding to 15hex.

When the output of the OP amp 321 is lowest (VOL nearly equal to 0 V), if the reference voltage corresponding to the target high-voltage output is lower than the feedback voltage (3.0 V), the OP amp 321 amplifies the difference between the reference voltage and the feedback voltage, and outputs the amplified difference, so the output of the integrator 320 increases gradually at a speed determined by the time constant given by the capacitor 22 and resistor 323.

The gradual increase of the output voltage of the integrator 320 causes a gradual increase of the gate voltage VG of the FET 340, so the capacitor 332 continues to be charged. A voltage divider is constituted of the resistors 324, 326, 331, and 333 and divides the output of the integrator 320 to produce the gate voltage VG of the FET 340.

The gate voltage, VG, of the FET 340 is given by

VG=VO×R2/(R1+R2) Eq. (1)

where VO is the output voltage of the OP amp 321, R1 is a resultant resistance in series between the output of the OP amp 321 and the gate of the FET 340, i.e., the sum of the resistors 324, 326, and 331, and R2 is the resistance between the gate and the ground and is equal to the resistor 333.

When the gate voltage VG of the FET 340 increases above the gate threshold voltage VTH, the FET 340 conducts.

When the FET 340 conducts, the drain current of the FET 340 flows from the 24 V power supply through the main winding 352 into the FET 340. The drain current through the main winding 352 causes a voltage across the auxiliary winding 351 due to inductive action, the voltage being fed to the gate of the FET 340 through the differentiator 330. Thus, the gate voltage VG decreases and the current flowing through the main winding 352 is shut off, so that the voltage across the auxiliary winding 351 disappears. The gate voltage VG of the FET 340 then increases above the gate threshold voltage VTH, causing the FET 340 again conducts. In other words, the positive feedback occurs with the aid of inductive coupling between the main winding and auxiliary winding. In this manner, the currents flowing through the main winding 352 and the auxiliary winding 351 alternate between the ON state and OFF state, hence self-oscillation.

The current through the main winding 352 alternates between the ON and OFF states, producing a stepped-up AC voltage across the secondary winding 353. The AC voltage across the secondary winding 353 is rectified by the rectifying circuit 360, which in turn outputs a negative high-voltage output on the node 390C. The negative high-voltage output is then supplied to the charging roller 136K through a resistor 477.

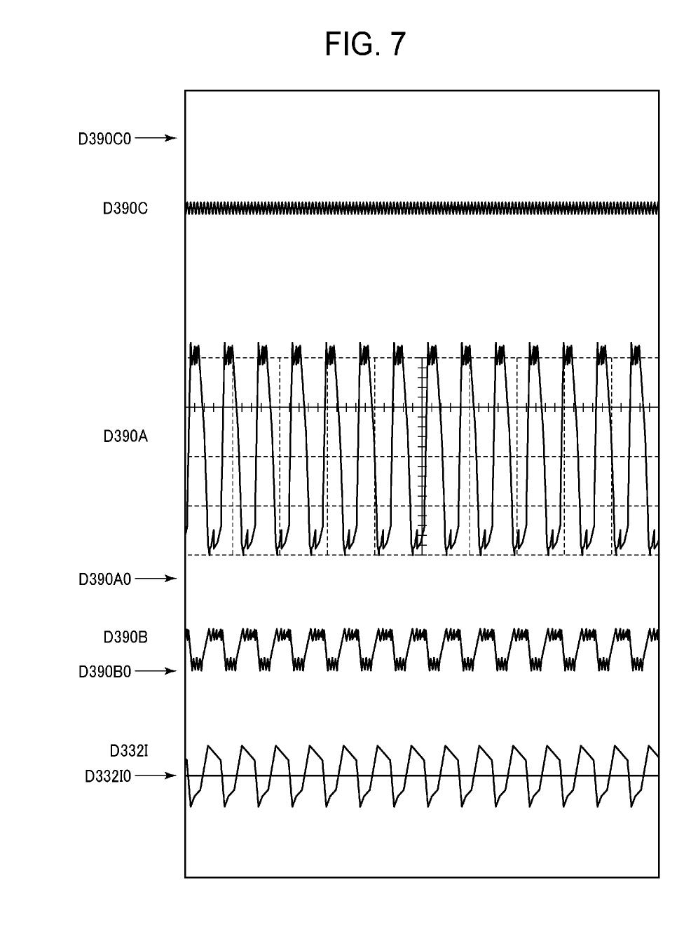

The frequency of self-oscillation is determined by the self-inductance, mutual inductance and parasitic capacitances of the primary winding and secondary windings of the step-up transformer 350, and the capacitance of the rectifying circuit 360. The self-oscillation is caused by the ON/OFF operations of the FET due to positive feedback with the frequency given by the LC resonance of inductance and capacitance. The frequency is also dependent on the current that flows into the charging roller 136K. Upon oscillation, an AC signal is fed to the gate of the FET 340. During oscillation, the input and output of the differentiator 330 change as depicted at D390A and D390B, respectively, shown in FIG. 7, and the current as depicted at D332I in FIG. 7 flows through the capacitor 332.

During oscillation, only a very small current flows through the resistor 331, and the switching operation of the FET 340 is mainly controlled by the current through the capacitor 332.

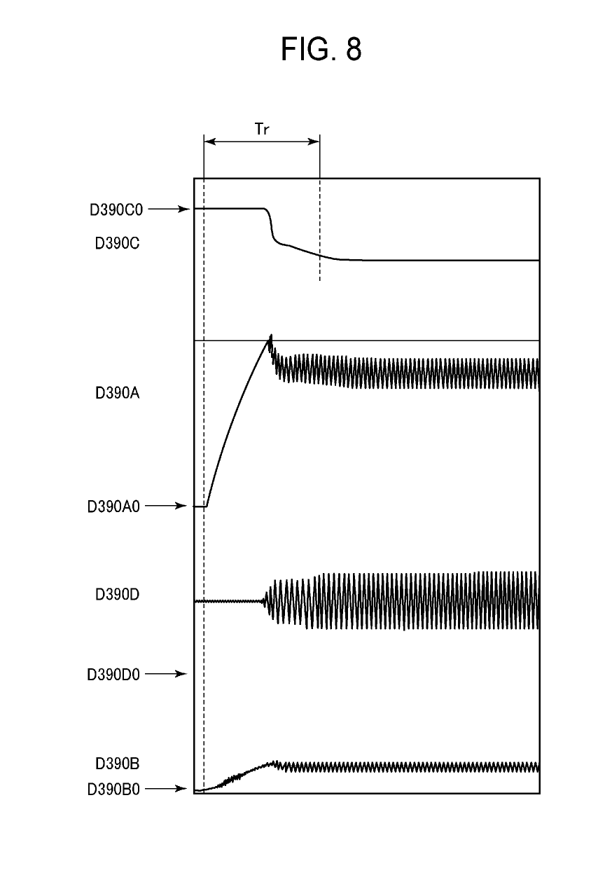

The AC voltage developed across the secondary winding 353 is rectified by the rectifying circuit 360 into a DC voltage depicted at D390C in FIG. 7. The DC voltage is fed to the charging roller 136K through a resistor 380. The output voltage converter 370 steps down the DC voltage, and feeds back the stepped down voltage to the integrator 320. References D390A0, D390B0, D3900C0, and D390D0 in FIGS. 8-11 denote the zero levels of waveforms D390A, D390B, D390C, and D390D.

The integrator circuit 320 compares the reference voltage received from the D/A converter 260a with the feedback voltage received from the output voltage converter 370. If the feedback voltage is higher than the reference voltage, the output VO of the OP amp 321 increases, which in turn causes the gate voltage VG (i.e., D390B) of the FET 340 to increase. The increase in the gate voltage VG causes an increase in the drain current of the FET 340. If the feedback voltage is lower than the reference voltage, the output VO decreases, and therefore the gate voltage VG of the FET 340 decreases causing the drain current to decrease. When neither the reference voltage nor the feedback voltage changes, the output VO of the OP amp 321 does not change significantly.

FIG. 7 illustrates the waveforms at various parts of the high-voltage power supply 240 when the high-voltage output is −1500 V, the resistance of the charging roller 136K is 2.5 MΩ, the resistors 331 and 333 are 100 kΩ, and the capacitor 332 is 330 pF. The resistors 331 and 333 are preferably in the range of 30 to 150 kΩ. The FET 340 is implemented with silicon N-channel MOSFET “RCD050N20” available from ROHM. The gate input capacitance of the RCD050N20 is 380 pF. Thus, the capacitor 332 is selected to have a capacitance close to the gate input capacitance.

When the drain current is smaller than 1 A, the gate threshold voltage VTH of the FET is in the range of 3 to 7 V. If the resistors 324 and 326 are 56 kΩ and 1 kΩ, respectively, and the resistors 331 and 333 are 100 kΩ, then the output voltage VO of the OP amp 321 is 18 V for a gate voltage VG of 7V, and 7.7 V for a gate voltage, VG, of 3 V. The resistance of the resistors 324, 326, and 331, and 333 is selected in consideration of the drain current. Thus, the resistance is selected such that when the output voltage VO of the OP amp 321 has its highest value or slightly lower than the supply voltage of 24 V, the gate voltage VG is above the gate threshold voltage VTH.

GTH, VOH, R1, and R2 are related as follows:

GTH>VOH×(R2/(R1+R2))

where GTH is a gate threshold voltage of the field effect transistor, R1 is a resultant resistance in series between the output of the integrator and the gate of the field effect transistor (FET), R2 is a resistance between the gate of the field effect transistor and the ground, and a maximum output voltage of the integrator.

The lower resistance of the resistors 324, 326, 331, and 333 causes a larger power loss of the FET 340, causing the FET 340 to heat. For example, the resistors 331 and 333 shown in FIG. 5 lower than 30 kΩ increased heat generated in the FET 340. If the resistor 331 had a low resistance through which a considerable amount of AC current flows, the drain current increased excessively causing intermittent oscillation. The large current caused the FET 340 to breakdown. If the capacitor 332 had a capacitance in the range of 200 to 530 pF, the circuit operated normally. The capacitor 332 having a capacitance of 100 pF, which is not large enough, caused intermittent oscillation and the FET 340 broke down. The capacitor 332 having a capacitance of 680 pF did not cause the FET 340 to break down but caused intermittent oscillation. When the capacitor 332 is within the range of 200 to 530 pF, the larger capacitance is, the less power loss of the FET 340 is, hence less heat. The capacitor 332 is preferably in the range of ½ to 3/2 of the gate capacitance of the FET 340. However, when the charging voltage generating section 261K supplies a high-voltage output of −1500 V and a current of few hundred μA, the junction temperature of the FET 340 did not exceed 70° C. at room temperature under any conditions.

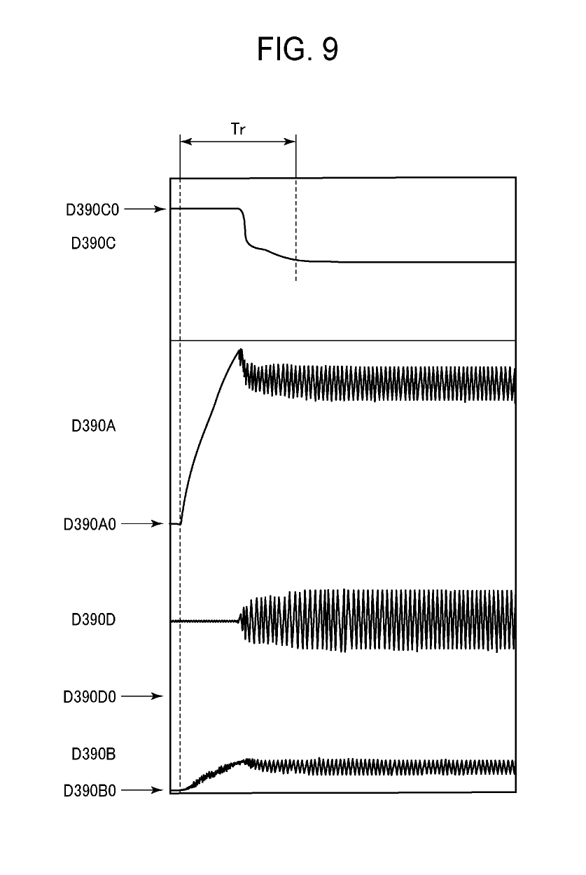

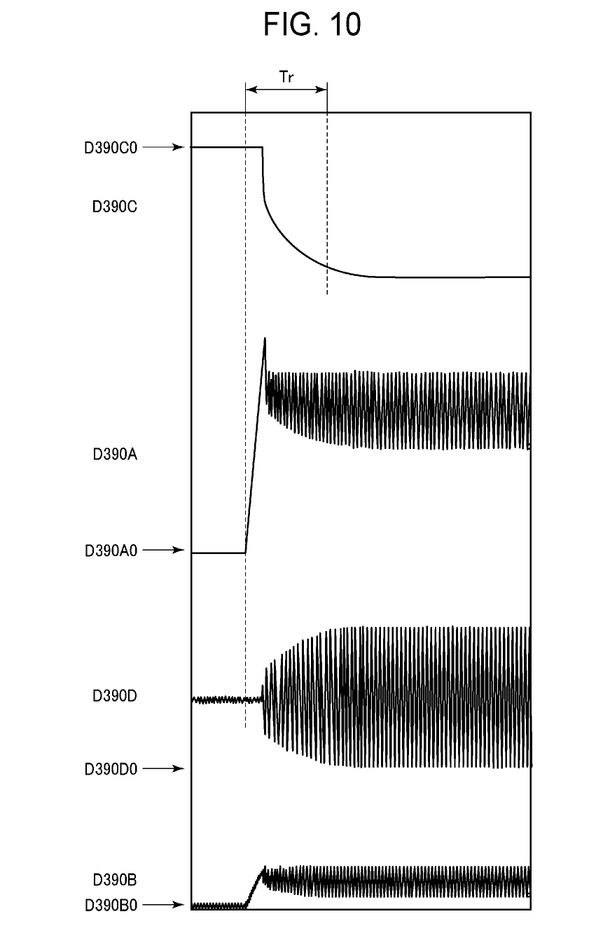

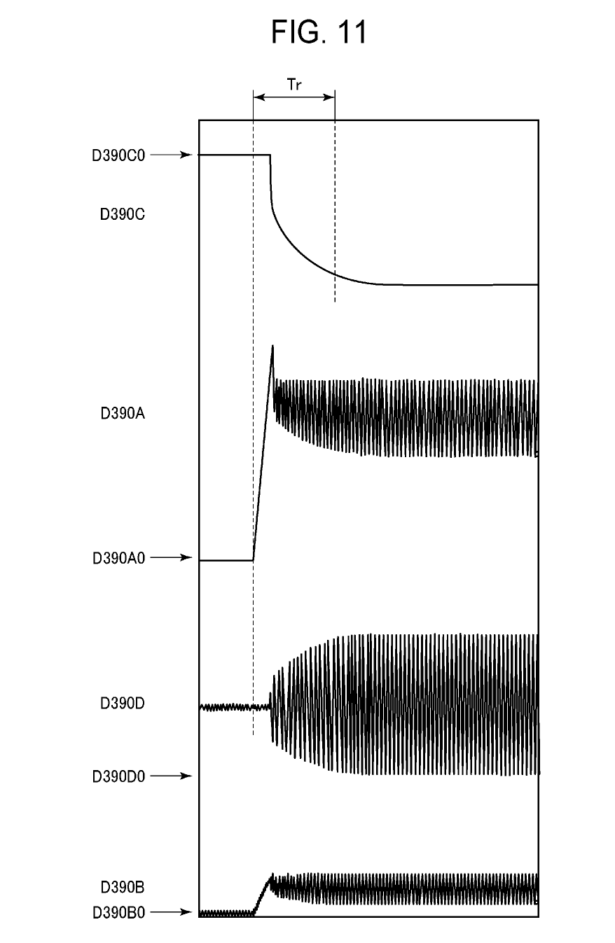

The output of the integrator 320 causes the drain current of the FET 340 to increase until the reference voltage is 0.272 V, which is the same as the feedback voltage, and reaches a stable value when the high-voltage output reaches −1500 V. FIGS. 8 and 9 illustrate the waveforms when the charging voltage generating section 261K starts toward the target high-voltage output of −650 V shortly after the print engine controller 220 outputs serial data indicative of 8Chex to the D/A converter 260a. Likewise, FIGS. 10 and 11 illustrate the waveforms at various parts of the circuit when the charging voltage generating section 261K starts up toward the target high-voltage output of −1500 V shortly after the print engine controller 220 outputs serial data indicative of 15hex to the D/A converter 260a.

The references D390A-D390D shown in FIGS. 8 and 9 denote waveforms illustrating changes in the potential of the nodes 390A-390D shown in FIG. 4. References D390A0-D390D0 denote the zero levels for these waveforms. For the results shown in FIGS. 8-11, the resistors 331 and 333 were 100 kΩ and the capacitor 332 was 330 pF. The startup time or rise time Tr is 31.0 ms for −650 V at no load as shown in FIG. 8. The rise time Tr is 33.0 ms for −650 V and a 5 MΩ load as shown in FIG. 9. The rise time Tr is 22.8 ms for a high-voltage output of −1500 V at no load as shown in FIG. 10. The rise time Tr is 23.8 ms for a high-voltage output of −1500 V and a 5 MΩ load as shown in FIG. 11. In other words, the rise time Tr is slightly longer than 30 ms for a high-voltage output of −650 V and about 23 ms for a high-voltage output of −1500 V.

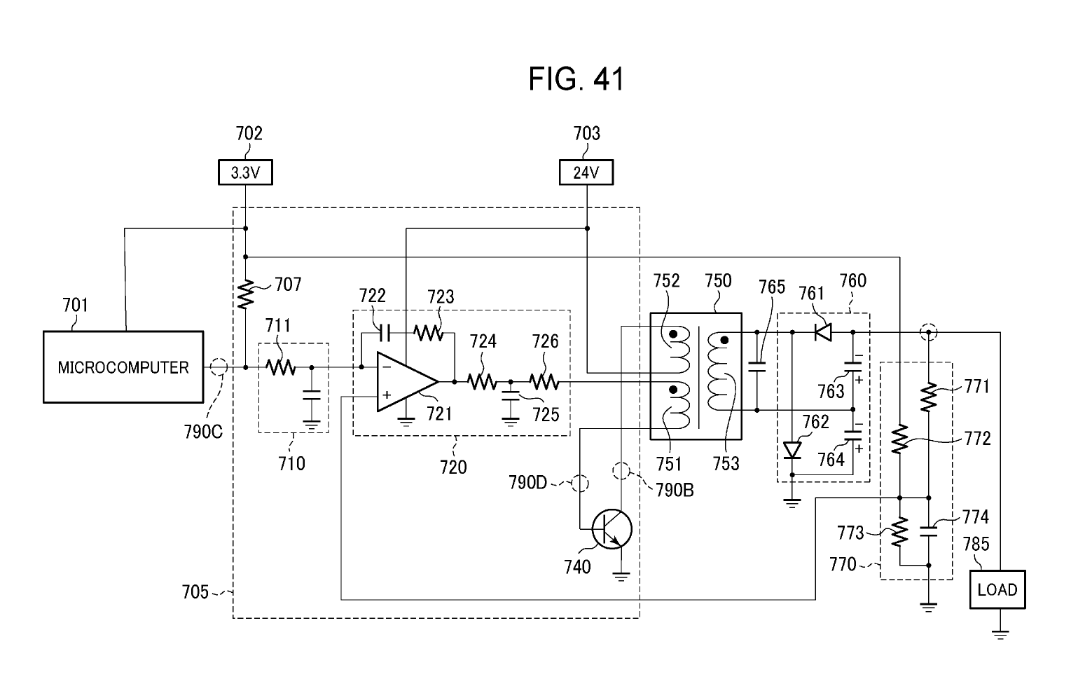

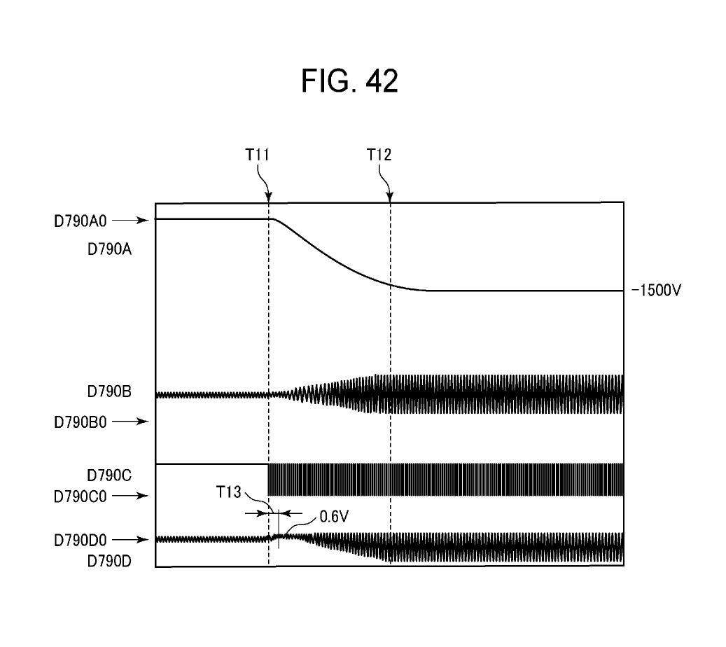

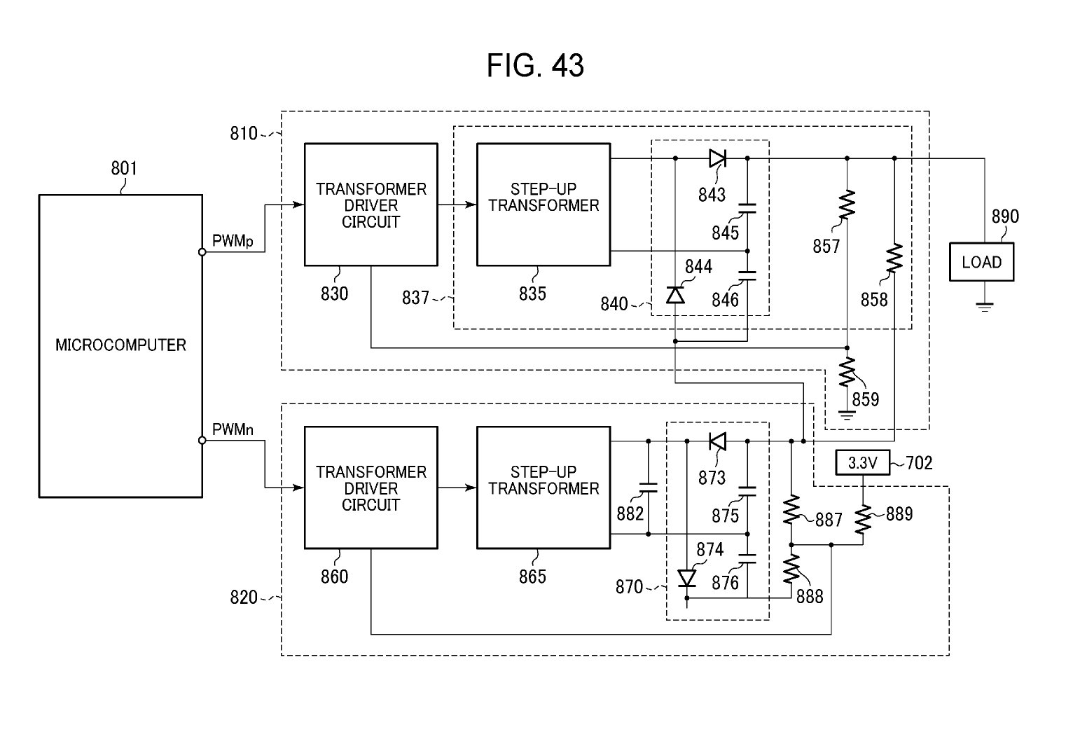

The rise time Tr is longer than that (i.e., T11-T12) shown in FIG. 42 of the conventional charging voltage generating section shown in FIG. 41.

However, when the above described configuration of the embodiment is applied to the charging voltage generating section, the longer rise time is not a problem. This is because the charging voltage generating section is turned on prior to a printing operation, and remains turned on until a series of printing operations are completed.

The step-up transformer 350 has the structure shown in FIGS. 6A and 6B. The auxiliary winding 351 having 5 turns was wound on the bobbin and the main winding 352 having 30 turns was wound on the auxiliary winding 351. The bobbin on the secondary side is divided into four sections by partitions 513b, 513c, and 513d. The secondary winding has a total of 1200 turns, i.e., 300 turns in each section. A partition 513a is located between the primary side 511 and the secondary side 512. When the charging voltage generating section 261K is operated without a load, the self-oscillation frequency of the circuit was about 100 kHz. When the charging voltage generating section 261K outputs a high-voltage output of −1500 V to a load of 2.5 MΩ, the self-oscillation frequency of the circuit was about 70 kHz.

When the charging voltage generating section outputs a high-voltage output of −1500 V to a 5 MΩ load, the power consumption was 24 V×43 mA=1.032 W. The high-voltage output of −1500 V supplies 300 μA into the 5 MΩ load, hence the output power of −1500 V×300 μA=0.45 W. Thus, the efficiency was 44%. The efficiency of the conventional circuit shown in FIG. 41 was 38%. This implies that the efficiency was improved by 6%. If the sum of the load current and current that flows through the feedback circuit is 300 μA, the loss due to the current flowing through the feedback circuit is substantially the same as in the conventional apparatus.

As described above, the FET is a part of the self-oscillation circuit using a step-up transformer, and the output of the differentiator drives the FET, thereby controlling the operation of the self-oscillation and the drain current as well as achieving a highly efficient step-up operation of voltage. In addition, the self-oscillation frequency can be as high as 70 to 100 kHz, eliminating a high-voltage capacitor which would otherwise be required for implementing a low frequency oscillation. Further, the configuration makes it possible to use surface mount parts, which in turn reduces the height of the components mounted on the circuit board, hence a compact image forming apparatus.

### Second Embodiment

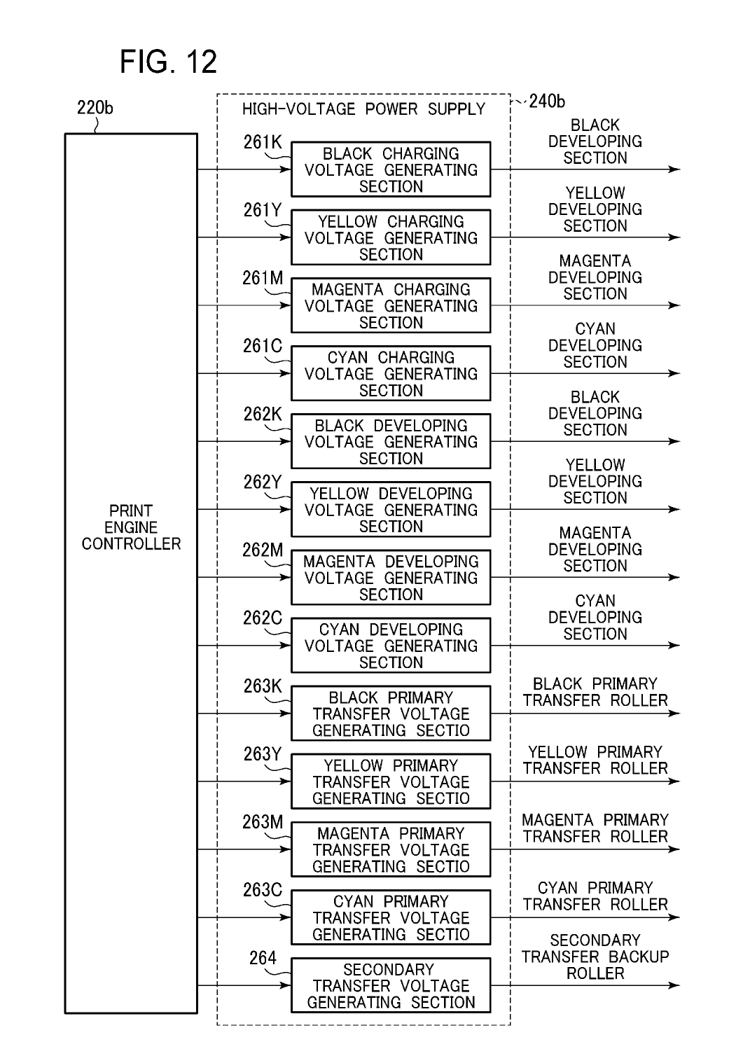

An image forming apparatus according to a second embodiment has the same configuration as that shown in FIGS. 1 and 2 except that a print engine controller 220b and a high-voltage power supply 240b are employed. The high-voltage power supply 240b generates a negative high-voltage output. Elements in FIG. 12 similar to those of the first embodiment have been given the same reference characters, and their description is omitted.

The print engine controller 220b outputs a pulse width modulation (PWM) signal corresponding to the target high-voltage output.

The high-voltage power supply 240b has not the microcomputer 260 shown in FIG. 3. Instead, the print engine controller 220b supplies the PWM signals to charging voltage generating sections 261K, 261Y, 261M, and 261C, and transferring voltage generating sections 263K, 263Y, 263M, and 263C.

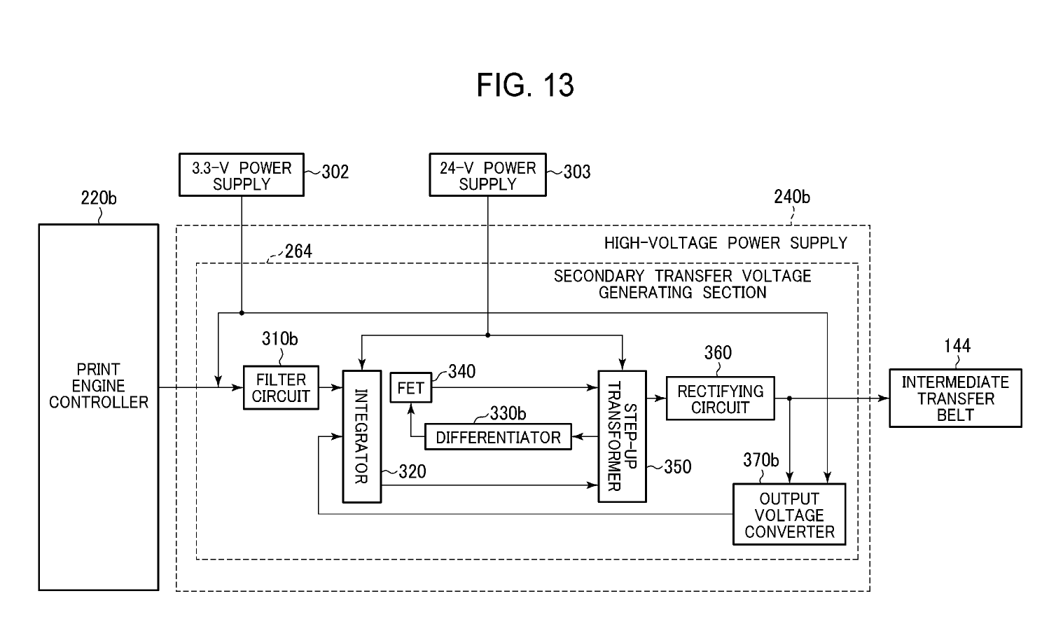

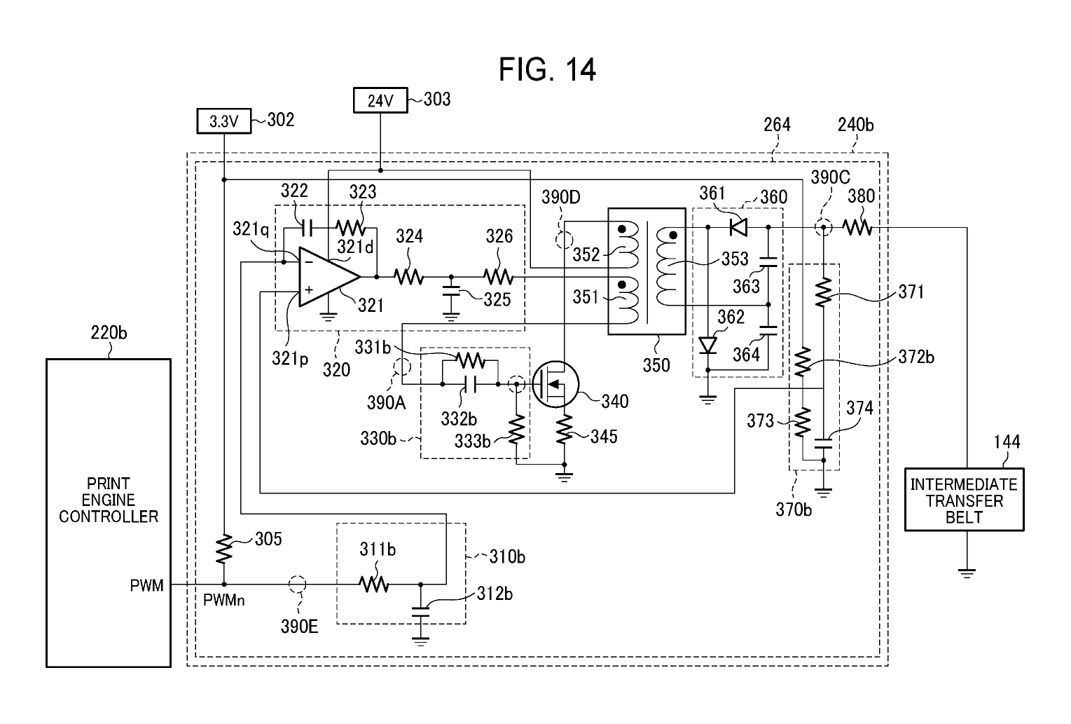

FIGS. 13 and 14 illustrate the details of the secondary transfer bias generating section 264 of the high-voltage power supply 240b shown in FIG. 12 together with the print engine controller 220b and power supplies 302 and 303. Elements similar to those in FIGS. 4 and 5 have been give the same reference characters. The charging voltage generating sections 261K, 261Y, 261M, and 261C, the developing voltage generating sections 262K, 262Y, 262M, and 262C, and the transferring voltage generating sections 263K, 263Y, 263M, and 263C are configured similarly.

FIG. 14 is the schematic diagram of the high-voltage power supply shown in FIG. 13.

The print engine controller 220b shown in FIGS. 13 and 14 outputs the PWMn signal corresponding to the target high-voltage output from the PWM output port. Actually, when the high voltage power supply 240b is to output the target high-voltage output, the print engine controller 220b initially outputs the PWMn signal corresponding to a high-voltage output much higher than the target high-voltage output, and then switches to another PWMn signal corresponding to the target output voltage. The high-voltage output higher than the target high-voltage output is, for example, highest output voltage in absolute value.

Referring to FIG. 14, a secondary transfer voltage generating section 264 includes a pull-up resistor 305, a filter circuit 310b, an integrator 320, a differentiator 330b, an FET 340, an overcurrent protection resistor 345, a step-up transformer 350, a rectifying circuit 360, and an output voltage converter 370b.

The filter circuit 310b includes a resistor 311b and a capacitor 312b. The filter circuit 310b is connected to a 3.3 V power supply 302 through the pull-up resistor 305. The PWMn signal is outputted from the print engine controller 220b and is fed to the integrator 320 through the filter circuit 310b. The differentiator 330b is formed of 56 kΩ resistors 331b and 333b and a 530 pF capacitor 332b.

The source of the FET 340 is connected to the ground through a 0.1Ω overcurrent protection resistor, so that when an excess current flows from drain to source of the FET 340, the potential of the source increases, lowering the gate-to-source voltage to cause the FET 340 to turn off. The output voltage converter 370b includes a 55 kΩ resistor 372b in place of the 100 kΩ resistor 372 shown in FIG. 5.

The circuit shown in FIGS. 13 and 14 operates substantially the same way as that shown in FIGS. 4 and 5 except for the following.

FIG. 15 illustrates the operation of the circuit shown in FIGS. 13 and 14 when the high-voltage power supply 240b starts up. Reference characters D390B, D390C, D390D, and D390E shown in FIG. 15 denote the potentials or waveforms at nodes 390B, 390C, 390D, and 390E in the circuit shown in FIG. 14, respectively. Reference characters D390B0, D390C0, D390D0, and D390E0 denote the zero level of the waveforms D390B, D390C, D390D, and D390E, respectively.

When the high-voltage power supply 240b is not to output the high-voltage output (duration T21 in FIG. 15), the print engine controller 220b outputs a PWMn signal having a duty cycle of 100% from the PWM port. The PWM port is connected to a 3.3 V power supply 302 through the pull-up resistor 305. Thus, when the PWMn signal has the High level, the potential at the PWM port is pulled up to 3.3 V. The 3.3 Vat the PWM port is inputted to an inverting input 321q of the OP amp 321 through the filter circuit 310b.

When the high-voltage power supply 240b is not to output the high-voltage output, the 3.3 V voltage supplied from the power supply 302 is divided by the 55 kΩ resistor 372b and the 1 MΩ resistor 373 of the output voltage converter 370b, so that 3.13 V is fed as a feedback voltage to the non-inverting input 321p of the OP amp 321. The feedback voltage reflects the voltage of the high-voltage output. The voltage fed to the inverting input 321q is higher than the voltage at the non-inverting input 321p, so that the output voltage of the OP amp 321 is lowest (VOL is substantially 0 V).

With this condition, the gate voltage VG of the FET 340 is sufficiently lower than a gate threshold voltage VTH, so that the FET 340 remains off. No current flows through the step-up transformer 350 and no high-voltage output appears on the node 390C.

When the high-voltage power supply 240b is to output the high-voltage output, the print engine controller 220b initially outputs a PWMn signal having a duty cycle corresponding to an output voltage with a larger absolute value than the target high-voltage output. This output voltage with a larger absolute value than the target high-voltage output is preferably largest in absolute value. After a predetermined period of time, the print engine controller 220b switches the PWMn signal to that having a duty cycle corresponding to the target high-voltage output. The duty cycle is 0% when the high-voltage output is largest in absolute value. Thus, the print controller 220b sets the PWMn signal to the Low level, and holds the PWMn signal at the Low level for a predetermined period of time, e.g., 3.76 ms (duration T22 in FIG. 15). The print engine controller 220b then switches the duty cycle of the PWMn signal to that corresponding to the target high-voltage output at a time T23 shown in FIG. 15. When the high-voltage power supply 240b is not to output the high-voltage output, the print engine controller 220b switches the duty cycle of the PWMn signal to the High level.

The PWMn signal according to the second embodiment has a frequency of 40 kHz. A higher clock frequency causes a lower resolution. Too low a clock frequency causes a large amount of ripple in the high-voltage output. Therefore, the clock frequency should be in the range of 20 to 60 kHz. Resolution of the feedback control of the high-voltage power supply 240b may be improved by, for example, varying the duty cycle of each pulse.

The output voltage converter 370b according to the second embodiment employs the 55 kΩ resistor 372b in place of the 100 kΩ resistor 372 used in the first embodiment. The high-voltage power supply 240b is capable of outputting a high-voltage output of up to −3000 V. In the first embodiment, the high-voltage output can be in a wide range of −650 to −1500 V and the charge voltage generating section can start up in tens of milliseconds. This performance was sufficient as long as the charging voltage is concerned. However, a secondary transfer bias voltage is required to start up in a shorter time. This is because the secondary transfer bias voltage needs to be applied to the secondary transfer roller 156 only after the print paper 150 has arrived at a nip 156N. If the secondary transfer bias voltage is applied to the secondary transfer roller before the print paper arrives at the nip 156N, the toner on an intermediate transfer belt 141 will have been transferred directly onto the secondary transfer roller 156. Another reason for the requirement of a short startup time is that the high-voltage output must be outputted while the leading margin of the print paper is passing through the nip 156N. The range of the high-voltage output varies in accordance with the environmental temperature and the type of print paper. For this reason, when the high-voltage output is relatively low, care should be taken to prevent the gate ON time of the FET 340 from becoming too long.

When the target high-voltage output is relatively low and therefore the reference voltage is high (i.e., PWM signal has a large duty cycle), the difference between the voltage at the inverting input and the non-inverting input of the OP amp 321 is small, so that the output of the OP amp 321 slowly increases, causing a longer gate ON time. The conventional circuit shown in FIG. 41 requires the gate ON time as short as T13 before the base voltage rises to about 0.6 V as shown in FIG. 42. In the second embodiment, the FET 340 is used in place of the bipolar transistor 740 and the output of the OP amp 321 is divided by the resistors 324, 326, 331, and 333 before being fed to the gate of the FET 340. Thus, the second embodiment requires a longer time before the gate voltage VG reaches a gate threshold voltage VTH of 3 to 4 V, hence long gate ON time.

In the second embodiment, the print engine controller 220b maintains the PWMn signal to the Low level until the gate voltage VG of the FET 340 reaches the gate threshold voltage VTH (about 3.76 ms) to provide a large voltage difference between the non-inverting input and the inverting input, thereby accelerating the rising of the gate voltage VG, hence the rising of the high-voltage output of the high-voltage power supply 240b. For example, when the target high-voltage output is −1000 V, the print engine controller 220b switches the PWMn signal from the High level to the Low level, maintains the Low level for 3.76 ms, and then outputs a PWMn signal having a duty cycle of 67%.

For a target high-voltage output of −3000 V, the print engine controller 220b switches the PWMn signal from the High level to the Low level, and then maintains the Low level longer than 3.76 ms. The duty cycle of the PWMn signal corresponding to the target high-voltage output of −3000 V is 0%. Therefore, it can be said that the first 3.76 ms period is required for the PWMn signal to remain low and the following period of low level is a period for outputting the PWMn signal corresponding to the target high-voltage output.

As described above, the PWMn signal is maintained low for a predetermined time immediately before the high-voltage output is outputted, thereby shortening the time (i.e., gate ON time) from when the print engine controller 220b starts to output the PWMn signal corresponding to the target high-voltage output until the FET 340 turns on.

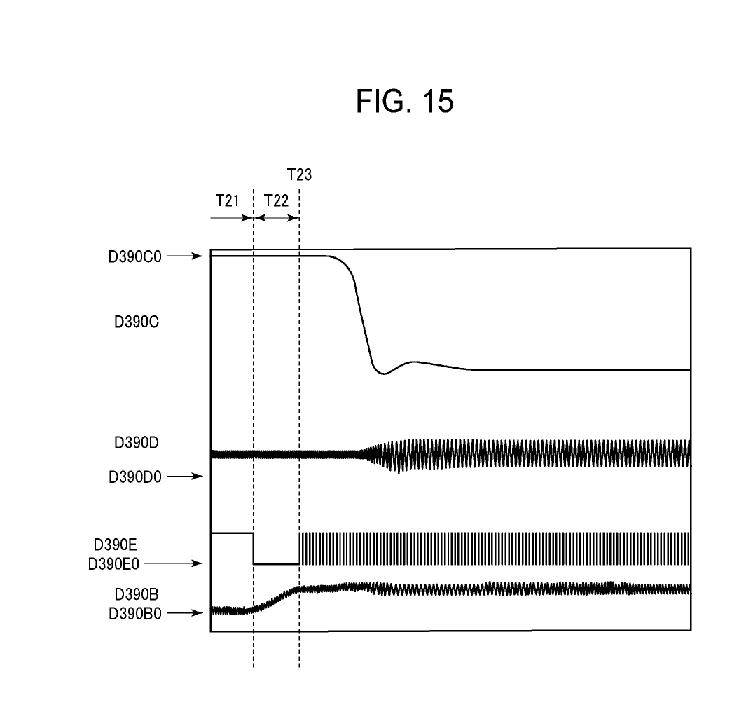

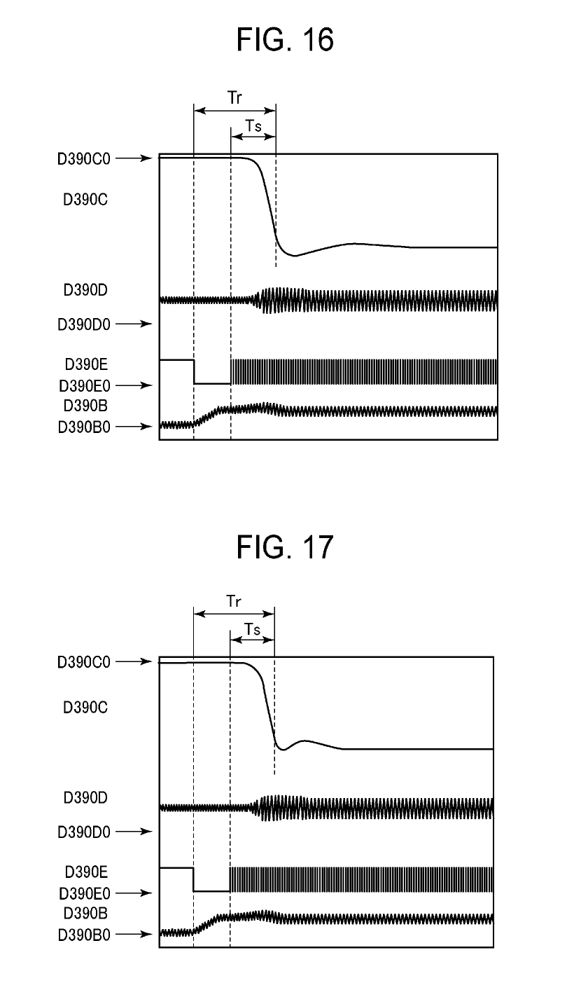

FIGS. 16-19 illustrate the waveforms when the high voltage power supply 240b starts up toward the target high-voltage output. The reference characters D390B-D390E denote the waveforms of the nodes 390B-390E shown in FIG. 14. Reference characters D390B0-D390E0 denote the zero levels of these waveforms.

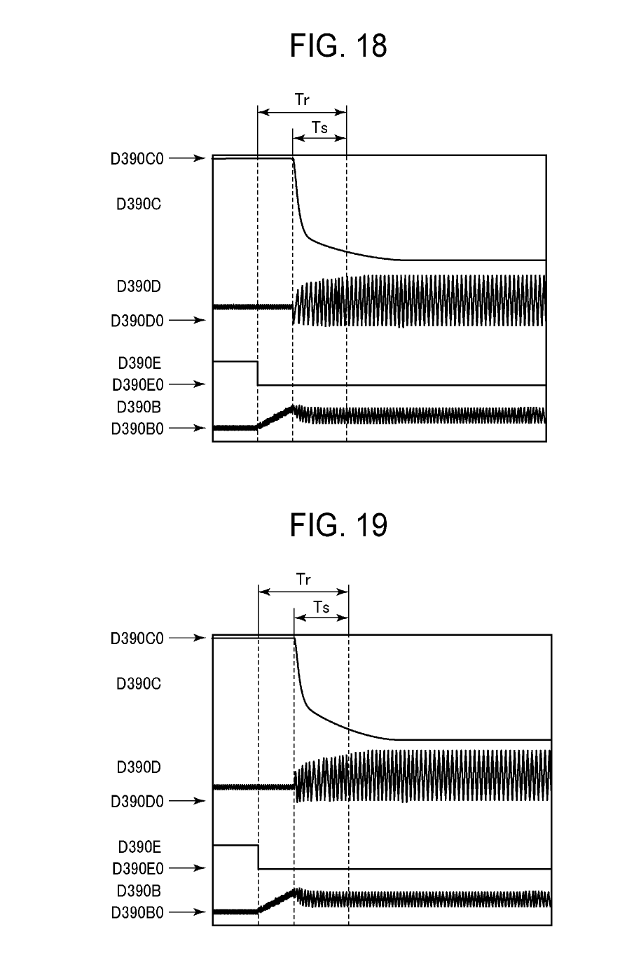

When the high-voltage power supply 240b operates without a load and outputs a high-voltage output of −1000 V, the startup time or rise time Tr is 9.6 ms as shown in FIG. 16. When the high-voltage power supply 240b operates with a load of 5 MΩ and outputs the high-voltage output of −1000 V, the startup time or rise time Tr is 9.84 ms as shown in FIG. 17. When the high-voltage power supply 240b operates without a load and outputs a high-voltage output is −300 V, the startup time or rise time Tr is 10.8 ms as shown in FIG. 18. When the high-voltage power supply 240b operates with a load of 5 MΩ and outputs the high-voltage output of −300 V, the startup time or rise time Tr is 12.1 ms as shown in FIG. 19. However, it can be said that the first 3.76 ms of the above startup times is the time before the PWMn signal corresponding to the target high-voltage output is outputted and therefore the actual startup time is obtained by subtracting 3.76 ms from the above startup times.

Thus, the startup time for the high-voltage output of −1000 V is slightly shorter than 10 ms, and the startup time for the high-voltage output of −3000 V is 10 to 12 ms. The gate voltage VG rises gradually toward the gate threshold voltage VTH for 3.76 ms during which the PWMn signal is maintained low but does not reach the gate threshold voltage VTH yet. The FET does not turn on yet and no high-voltage output is outputted yet. Thus, the print controller 220b switches the PWMn signal to the Low level 3.76 ms earlier than the arrival of the print paper 150 at the nip 156N, so that the actual startup time Ts for the high-voltage output of −1000 V is slightly longer than 6 ms and the actual startup time Ts for the high-voltage output of −3000 V is in the range of 7 ms to slightly higher than 8 ms.

In the above configuration, when the high-voltage power supply 240b starts up, the Low period of the PWMn signal is set to 3.76 ms. This period of time should be shorter than the gate ON time or should be at least a part of the gate ON time. The rate of increase of the gate voltage VG is determined by the time constant of the integrator implemented with the OP amp. Thus, the Low period of the PWMn signal should be selected by simulation or experiment in accordance with the integrator used in individual cases.

The capacitor 332b of the second embodiment was selected to be 530 pF, thereby achieving the junction temperature of the FET below 100° C. when the high-voltage power supply 240b outputs the high-voltage output of −3000 V to a 2.5 MΩ load at room temperature.

With the intermediate transfer system, if printing is performed on the print paper having a narrow width, most of the secondary transfer current flows directly through the intermediate transfer belt 141 and only a small fraction of the secondary transfer current flows through the print paper. Thus, it is necessary that the high-voltage power supply 240b is capable of supplying a large load current. In the present invention, when the capacitor 332 had a capacitance of 330 pF and the high-voltage power supply 240b operated at room temperature to supply the high-voltage output of −3000 V to the 2.5 MΩ load, the junction temperature of the FET was below 100° C.

In the above described configuration, the print engine controller 220b supplies the PWMn signal to the high-voltage power supply 240b. As described in the first embodiment, a setting signal or serial data indicative of a high-voltage output higher than the target high-voltage output may first be supplied to the D/A converter, thereby feeding the corresponding reference voltage to the integrator for a predetermined period of time, e.g., 3.76 ms. Subsequently to the predetermined period of time, the D/A converter receives the serial data indicative of the target high-voltage output, thereby feeding the reference voltage corresponding to the target high-voltage output may be fed to the integrator.

In the above described configuration, the setting signal is switched in a single step from a value indicative of a high-voltage output higher than the target high-voltage output to a value corresponding to the target high-voltage output. Instead, the setting signal may be switched in increments.

As described above, a field effect transistor (FET) is used in a transformer based self-oscillation circuit and a differentiator is used to drive the FET, thereby efficiently controlling both the self-oscillation and drain current of the FET to provide a good step-up operation of voltage. This configuration prevents components from heating up, making it possible to output a high-voltage output using the transformer used in the conventional apparatus and eliminating the need for a heat sink which would other be needed for a heavy load.

The setting signal is initially selected to be a value indicative of a high-voltage output higher than the target high-voltage output, and is then switched to a value indicative of the target high-voltage output. Therefore, circuit components having values suitable for a higher end portion of the range of the high-voltage output still provide as good a startup time as the conventional apparatus.

Further, the circuit can oscillate at a frequency as high as about 100 kHz when the high-voltage power supply 240b operates without a load. The frequency may be higher than 40 kHz even when the oscillation frequency decreases due to an increase in load, preventing objectionable, audible sounds from being generated. In addition, the FET may be implemented with a surface mount device, which reduces the height of components mounted on a circuit board and leads to a compact image forming apparatus.

### Modifications to First and Second Embodiments

The rectifying circuit 360 in the first and second embodiments takes the form of an all-wave rectifier. Instead, the rectifying circuit 360 may be a single-wave rectifier.

Although the first and second embodiments have been described with respect to a voltage generating section that generates a negative voltage, the invention may also be applicable to a voltage generating section that generates a positive voltage. For a positive voltage output, the direction of the diodes 361 and 362 is reversed and the feedback voltage is inputted to the inverting input of the OP amp and the reference voltage is fed to the non-inverting input.

If the second embodiment is employed for positive voltage generation, the setting signal is set to the Low level when the high-voltage output is not outputted, and is set to the High level corresponding to highest output voltage when the high-voltage power supply starts to output the high-voltage output, and is then set to a value corresponding to the target output voltage.

In the first embodiment, the settings outputting section supplies the setting signal to all the voltage generating sections. In the second embodiment, the print engine controller 220 supplies the PWMn signal to all the voltage generating sections. Alternatively, the print engine controller 220 may supply the PWMn signal to some of the voltage generating sections and the settings outputting section may supply the setting signal to the other voltage generating sections.

Some of the voltage generating sections may be implemented with a high-voltage power supply according to either the first embodiment or the second embodiment and the others of the voltage generating sections may be implemented with a high-voltage power supply according to neither the first embodiment nor the second embodiment.

If the settings outputting section includes a single D/A converter, the D/A converter may be configured to have a plurality of channels such that each voltage generating section may receive a setting output from a corresponding channel. Alternatively, a plurality of D/A converters may be employed such that each voltage generating section receives a setting output from a corresponding D/A converter.

The first and second embodiments have been described in terms of a color intermediate transfer image forming apparatus. The present invention may also be applied to a color image forming apparatus of direct transfer system. Alternatively, the first and second embodiments may be applicable to a monochrome image forming apparatus.

### Third Embodiment

### {Secondary Transfer Voltage Generating Section}

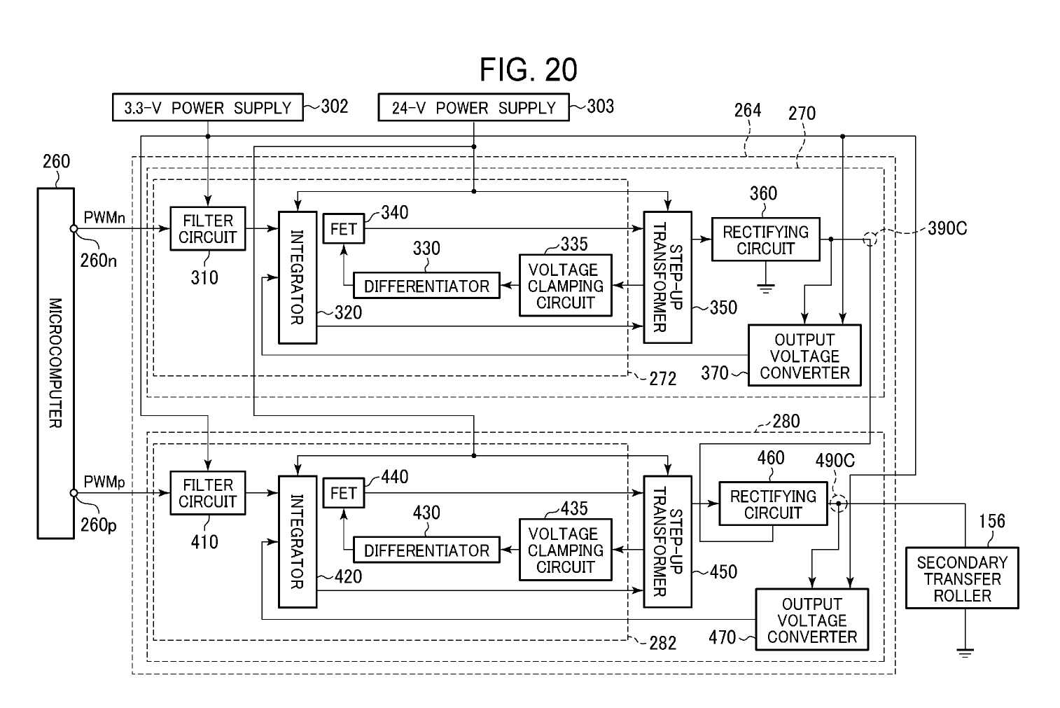

FIG. 20 illustrates the secondary transfer voltage generating section 264 of the high-voltage power supply 240 together with the microcomputer 260 and power supplies 302 and 303. The secondary transfer voltage generating section 264 includes a negative bias generator 270 and a positive bias generator 280.

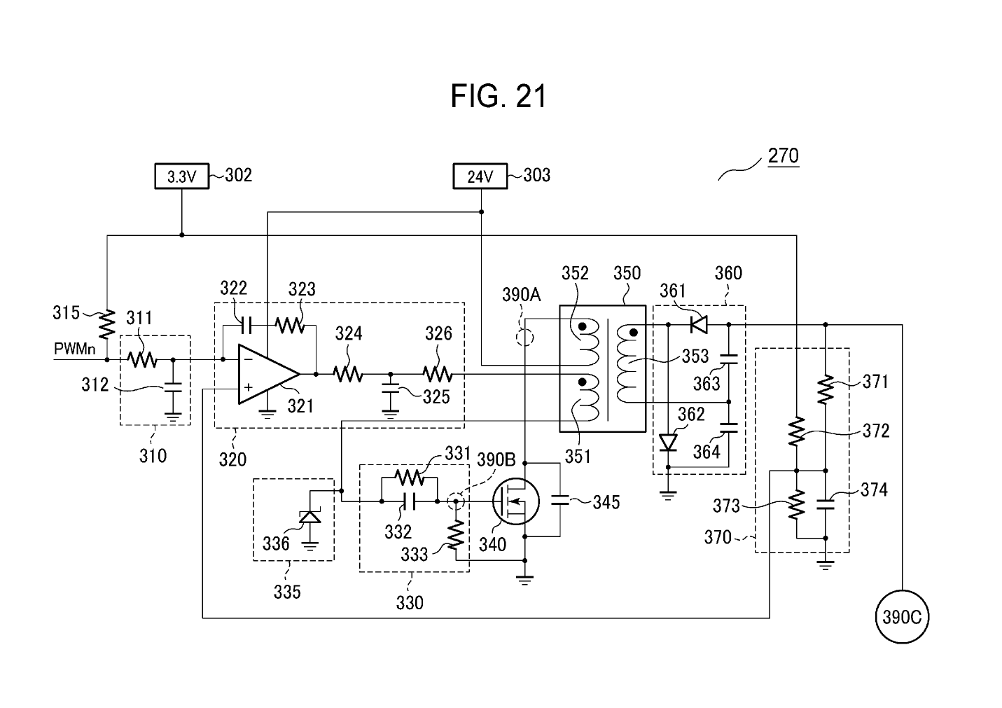

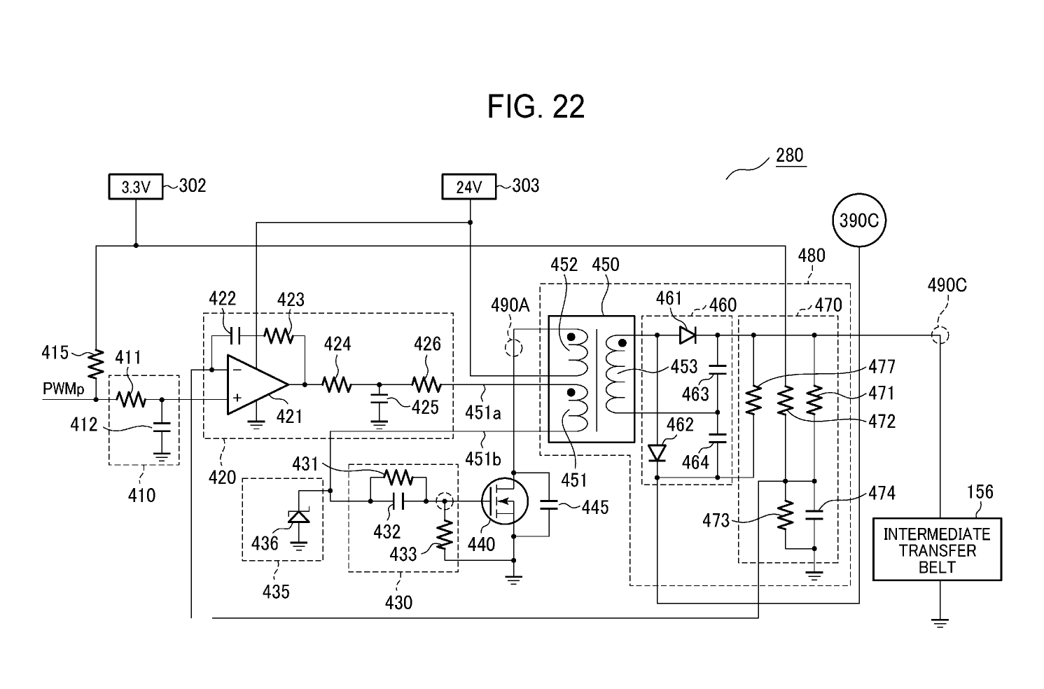

FIG. 21 is a schematic diagram of the entire negative bias generator 270 and FIG. 22 illustrates the entire positive bias generator 280.

The microcomputer 260 includes a serial communication interface (SCI) port 260a connected to an SCI port 220a of the print engine controller 220 as shown in FIG. 3. The microcomputer 260 receives commands from the print engine controller 220: a command instructing the target negative high-voltage output and a command instructing the target positive high-voltage output. The microcomputer 260 then outputs the PWMn signal, which corresponds to the specified target negative high-voltage output, through a PWMn output port 260n, and the PWMp, which corresponds to the specified target positive high-voltage output, through a PWMp output port 260p. The PWMn and PWMp signals have a frequency of, for example, 40 kHz.

### {Configuration of Negative Bias Generator}

Referring to FIGS. 20 and 21, the negative bias generator 270 includes a transformer driver circuit 272, a step-up transformer 350, a rectifying circuit 360, and an output voltage converter (voltage step-down circuit) 370. The transformer driver circuit 272 includes a filter circuit 310, an integrator 320, a differentiator 330, a voltage clamping circuit 335, a field effect transistor (FET) 340, and a capacitor 345. The FET 340 is, for example, an enhancement type N-channel MOSFET.

Referring to FIGS. 20 and 22, the positive bias generator 280 includes a transformer driver circuit 282, a step-up transformer 450, a rectifying circuit 460, an output voltage convertor 470. The transformer driver circuit 282 includes a filter circuit 410, an integrator 420, a differentiator 430, a voltage clamping circuit 435, the field effect transistor (FET) 440, and a capacitor 445. The FET 440 is, for example, an N-channel MOSFET.

The power supply 302 is a 3.3 V DC power supply, which is connected to the filter circuits 310 and 410 and the output voltage converters 370 and 470. The power supply 303 is a 24 V DC power supply, which is connected to the integrators 320 and 420 and step-up transformers 350 and 450.

Referring back to FIG. 21, the main winding 352, auxiliary winding 351, and FET 340 constitute an oscillator. The capacitor 345 is connected between the drain and source of the FET 340, and is one of the major factors that determines the oscillation frequency. The 3.3 V power supply 302 is connected through a pull-up resistor 315 to the PWMn output port 260n of the microcomputer 260. Likewise, as shown in FIG. 22, the capacitor 445 is connected between the drain and source of the FET 440, and is one of the major factors that determines the oscillation frequency. The 3.3 V power supply 302 is connected through a pull-up resistor 415 to the PWMp output port 260p of the microcomputer 260. The resistors 315 and 415 and capacitors 345 and 445 are omitted from FIG. 20.

The filter circuit 310 includes a resistor 311 having one end connected to the PWMn output port 260n, and a capacitor 312. The capacitor 312 has one end connected to the other end of the resistor 311 and the other end connected to the ground potential.

The PWMn signal outputted from the PWMn output port 260n is smoothed out by the filter circuit 310 into a DC signal having a voltage value corresponding to the duty cycle of the PWMn signal. The smoothed DC signal is then outputted as a reference voltage to the integrator 320.

The integrator 320 includes an OP amp 321 with an inverting input (−) to which the reference voltage is inputted, a series circuit of a capacitor 322 and a 56 kΩ resistor 323, a capacitor 325, and a 1 kΩ resistor 326. The series circuit has one end connected to the inverting input of the OP amp 321, and the other end connected to the output of the OP amp 321. The resistor 324 has one end connected to the output of the OP amp 321. The capacitor 325 has one end connected to the junction point of the resistors 324 and 326 and the other end connected to the ground.

The step-up transformer 350 has one end connected to the output of the resistor 326 and other end connected to the gate of the FET 340 through the differentiator 330.

The differentiator 330 includes a 56 kΩ resistor 331 (second resistor), a 2680 pF capacitor 332, and a 56 kΩ resistor 333 (third resistor). The resistor 331 has one end connected to one end of the auxiliary winding 351 and the other end connected to the gate of the FET 340. The resistor 333 has one end connected to the gate of the FET 340 and the other end connected to the ground.

The voltage clamping circuit 335 is connected between one end of the auxiliary winding 351 and the ground. The voltage clamping circuit 335 prevents the potential at the gate of the FET 340 from increasing above a predetermined upper value, and includes, for example, a Zener diode 336. In FIG. 21, the Zener diode 336 has a cathode connected to one end of the auxiliary winding 351 and an anode connected to the ground. The Zener diode 336 has a Zener voltage of, for example, 12 V.

The main winding 352, which is a part of the windings on the primary side of the step-up transformer 350, and has one end connected to the 24 V power supply 303 and other end connected to the drain of the FET 340. The source of the FET 340 is grounded. The capacitor 345 has a capacitance of, for example, 0.01 μF. The step-up transformer 350 uses, for example, an EE16 ferrite core.

The rectifying circuit 360 includes a high voltage diode 361, a high voltage diode 362, a high voltage capacitor 363, and a high voltage capacitor 364. A series circuit of the high voltage diodes 361 and 362 is connected in parallel with a series circuit of the high voltage capacitors 363 and 364. The secondary winding 353 has one end connected to the junction of the series circuit of the high voltage diodes 361 and 362, and the other end connected to the junction of the series circuit of the capacitors 363 and 364. The anode of the diode 361 serves as a positive output terminal of the rectifying circuit 360 and the cathode of the diode 362 serves as a negative output terminal.

The high-voltage output of the rectifying circuit 360 serves as a negative high-voltage output, and is supplied to a load or the secondary transfer roller 156 through the resistor 477. The resistor 477 will be described later in the description of the positive bias generator 280.

The output voltage converter 370 steps down the high-voltage output (voltage at a node 390C), and feeds the stepped down voltage to the non-inverting input (+) of the OP amp 321. The output voltage converter 370 includes a 3 MΩ high voltage resistor 371, a 3.6 kΩ resistor 372, a 110 kΩ resistor 373, and a capacitor 374. One end of the high voltage resistor 371 is connected to the negative output terminal of the rectifying circuit 360. The resistor 372 has one end connected to the 3.3 V power supply 302. The resistor 373 has one end connected to one of the respective ends of the resistors 371 and 372, and the other end connected to the ground. The resistor 373 has one end connected to the ground. The capacitor 374 is connected in parallel with the resistor 373. One end of the resistor 373 serves as an output terminal of the output voltage converter 370 and the voltage at the output terminal is fed as a feedback voltage to the non-inverting input (+) of the OP amp 321. The feedback voltage reflects the voltage of the high-voltage output.

The microcomputer 260 and filter circuit 310 constitute a reference voltage generating section that outputs a reference voltage corresponding to the target negative high-voltage output. Once the high-voltage output applied to the secondary transfer roller 156 becomes equal to the target voltage, this reference voltage has a value equal to that of the feedback voltage

The integrator 320 outputs the difference between the reference voltage, and the feedback voltage.

The output of the integrator 320 is supplied to the gate of the FET 340 through the auxiliary winding 351 and the differentiator 330. In this manner, the negative bias generator 270 performs feedback-control as a whole, so that the voltage applied to the secondary transfer roller 156 is the same as the target high-voltage output. Once self-oscillation is initiated, the output of integrator 320 controls the gate voltage (average voltage at the gate), i.e., operating point of the FET 340, and hence the drain current of the FET 340. In this manner, the currents flowing through the main winding 352 and the auxiliary winding 351 alternate between the ON state and the OFF state, hence self-oscillation. The differentiator 330 applies the AC signal outputted from the auxiliary winding 351 during the self-oscillation, to the gate of the FET 340 by capacitive coupling.

The current through the main winding 352 alternates between the ON and OFF states, producing a stepped-up AC voltage across the secondary winding 353. The AC voltage across the secondary winding 353 is rectified by the rectifying circuit 360, which in turn outputs a negative high-voltage output to the node 390C. The negative high-voltage output is then supplied to the secondary transfer roller 156 through a resistor 477.

The frequency of self-oscillation is determined by the self-inductance, the mutual inductance and stray capacitances of the primary winding and secondary windings of the step-up transformer 350, the capacitance of the rectifying circuit 360, and the current flowing into the secondary transfer roller 156.

During the operation, the voltage clamping circuit 335 limits the gate voltage of the FET 340 below a predetermined value, thereby preventing the current through the FET 340 from increasing excessively.

### {Configuration of Positive Bias Generator}

The filter circuit 410, pull-up resistor 415, integrator 420, differentiator 430, voltage clamping circuit 435, FET 440, capacitor 445, step-transformer 450, rectifying circuit 460, and output voltage converter 470 in the positive 280 are configured in the same way as the filter circuit 310, pull-up resistor 315, integrator 320, differentiator 330, voltage clamping circuit 335, FET 340, capacitor 345, step-transformer 350, rectifying circuit 360, and output voltage converter 370 in the positive 270.

The filter circuit 410 includes a resistor 411 having one end connected to the PWMp output port 260p and a capacitor 412 having one end connected to the other end of the resistor 411 and the other end connected to the ground. The PWMp signal outputted from the PWMp output port 260p is smoothed out by the filter circuit 410 into a DC signal having a voltage value corresponding to the duty cycle of the PWMp signal, the DC signal is then input as a reference voltage to the integrator 420.

The integrator 420 includes an OP amp 421 having a non-inverting input (+) to which the reference voltage is inputted, a series circuit of a capacitor 422 and a resistor 423 that connects the inverting input (−) of the OP amp 421 and the output of the OP amp 421, a series circuit of a 56 kΩ resistor 424 and a 1 kΩ resistor 426 and a capacitor 425. The series circuit of the resistors 424 and 426 is connected between the output of the OP amp 421 and one end 451a of the auxiliary winding 451. The capacitor 425 is connected between the ground and the junction of the resistors 424 and 426.

The auxiliary winding 451, which is a part of the primary windings of the step-up transformer 450, has one end 451a connected to the output of the integrator 420 and the other end connected to the gate of the FET 440 via the differentiator 430.

The differentiator 430 includes a 56 kΩ resistor 431 having one end connected to one end of the auxiliary winding 451 and the other end connected to the gate of the FET 440, a 2680 pF capacitor 432 in parallel with the resistor 431, and a 56 kΩ resistor 433 having one end connected to the gate of the FET 440 and the other end connected to the ground. The resistors 431 and 433 are preferably in the range of 30 to 150 kΩ.

The voltage clamping circuit 435 is connected between one end of the auxiliary winding 451 and the ground. The voltage clamping circuit 435 prevents the potential at the gate of the FET 440 from exceeding a predetermined value, and may be implemented with, for example, a Zener diode 436. In FIG. 22, the Zener diode 436 has a cathode connected to one end of the auxiliary winding 451 and an anode connected to the ground. The Zener diode has a Zener voltage of, for example, 12 V.

The main winding 452, which is a part of the primary windings of the step-up transformer 450, has one end connected to a 24 V power supply 303 and the other end connected to the drain of the FET 440. The source of the FET 440 is grounded. The capacitor 445 is connected across the drain and cathode of the FET 440, and is one of the major factors that determine the oscillation frequency. The capacitor 445 has a capacitance of, for example, 0.01 μF. The step-up transformer 450 uses, for example, a UU ferrite core.

The rectifying circuit 460 includes a series circuit of diodes 461 and 462, and a series circuit of capacitors 463 and 464. These two series circuits are connected in parallel with The junction point of the diodes 461 and 462 is connected to one end of the secondary winding 453, and the junction point of the capacitors 463 and 464 is connected to the other end of the secondary winding 453. The rectifying circuit 460 rectifies the output of the secondary winding 453. The cathode of the diode 461 serves as a positive output terminal and the anode of the diode 463 serves as a negative output terminal. The rectifying circuit 460 is configured in a similar way to the rectifying circuit 360 except that the polarities of the diodes are opposite and the high-voltage output is positive. The negative output terminal of the rectifying circuit 460 is not grounded but is connected to the node 390C of the negative bias generator 270.

The high-voltage output of the rectifying circuit 460 is supplied as a positive high-voltage output to the secondary transfer roller 156.

The output voltage converter 470 steps down the high-voltage output at the node 490C to produce the feedback voltage, which in turn is fed to the inverting input (−) of the OP amp 421. The output voltage converter 470 includes a series circuit of a resistor 471 and a parallel circuit of a 51 kΩ resistor 473 and a capacitor 474. One end of the resistor 471 is connected to the node 490C, and one end of the parallel circuit of the resistor 473 and capacitor 474 is grounded. The output voltage converter 470 also includes a 100 MΩ resistor 471 having one end connected to the node 490c, and a resistor 472 through which the 3.3 V power supply 302 is connected to the junction of the resistor 471 and the parallel circuit of the resistor 473 and capacitor 474.

The step-up transformer 450, rectifying circuit 460, and output voltage converter 470 constitute a step-up mold transformer 480.

The microcomputer 260 and filter circuit 410 constitute a reference voltage generator which produces a reference voltage corresponding to the target positive high-voltage output. When the high-voltage output supplied to the load is equal to the target high-voltage output, the reference voltage supplied from the filter circuit 410 is equal in value to the feedback voltage.

The integrator 420 outputs the voltage corresponding to the difference between the reference voltage and the feedback voltage, which will be described later.

### {Initiation of Self-Oscillation}

The output of the integrator 420 is supplied to the gate of the FET 440 through the auxiliary winding 451 and the differentiator 430, the positive bias generator 280 performs feedback-control as a whole, so that the high-voltage output supplied to the secondary transfer roller 156 is equal to the target high-voltage output. When the output of the integrator 420 decreases, the gate voltage of the FET 440 decreases, causing the current through the main winding 452 to decrease. The gate voltage below the gate threshold voltage VTH causes the FET 440 to turn off, so that the 24 V power stops supplying current into the FET 440 through the main winding 452.

When the output of the integrator 420 increases, the gate voltage of the FET 440 increases. The gate voltage above the gate threshold voltage VTH causes the FET 440 to turn on, so that the 24 V power supplies current into to the FET 440 through the main winding 452. This current causes a voltage to be developed across the auxiliary winging 351, the voltage having a polarity that causes the gate voltage VG to decrease. The voltage across the auxiliary winding 451 is fed to the gate through the differentiator 430, and causes the FET 440 to turn off. The turning off of the FET 440 causes the voltage across the main winding 452 to reverse its polarity, hence the voltage across the auxiliary winding 451 also reverses its polarity. The voltage across the auxiliary winding 451 now increases the gate voltage VG, so that the current through the FET 440 increases. In other words, the positive feedback occurs with the aid of inductive coupling between the main winding and auxiliary winding. In this manner, the currents flowing through the main winding 452 and the auxiliary winding 451 alternate between the ON and OFF states while changing their polarities. During the oscillation, the AC signal outputted from the auxiliary winding 451 is applied to the gate of the FET 440 through capacitive coupling via the differentiator 430.

The current through the main winding 452 alternating between the ON and OFF states causes the stepped up AC voltage to appear across the secondary winding 453. The AC voltage is then rectified by the rectifying circuit 460 before a DC positive voltage appears on the node 490C and is supplied to the secondary transfer roller 156.

The frequency of the self-oscillation is determined by the self-inductance of the primary and secondary windings and the mutual inductance between these windings, the stray capacitance of these windings, the capacitance of the rectifying circuit 460, and the current flowing into the secondary transfer roller 156.

In this operation, the clamping circuit 435 prevents the gate voltage of the FET 440 from exceeding a predetermined value, so that no excessive current will flow through the FET 440.

### {Step-Up Transformer}

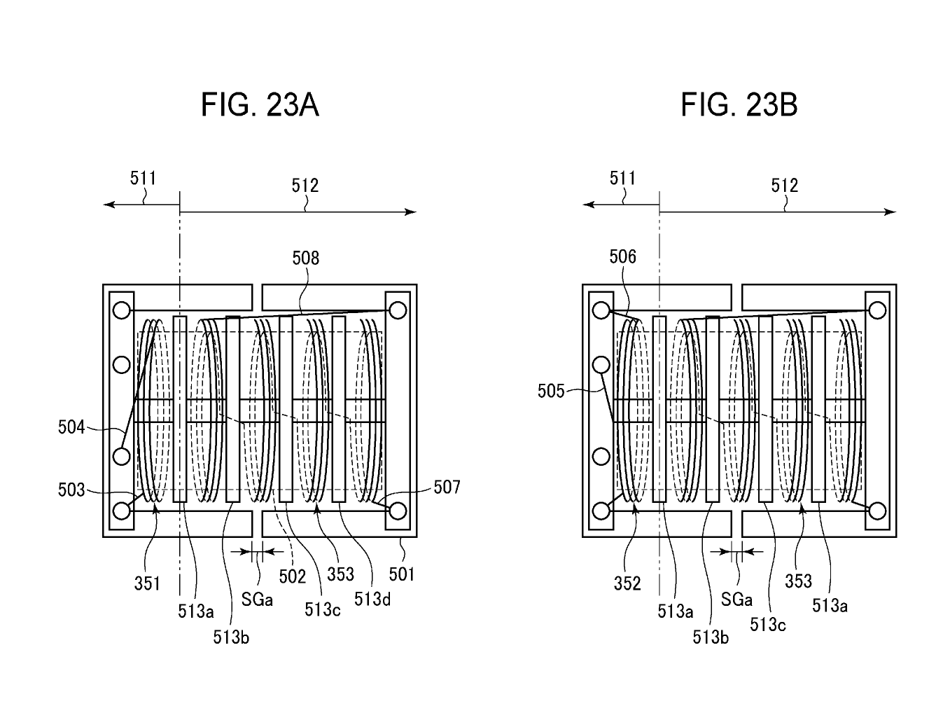

FIGS. 23A and 23B illustrate the outline of the step-up transformer 350 shown in FIG. 21. The step-up transformer 350 has a primary side 511 and a secondary side 512. The main winding 351, auxiliary winding 352, and secondary winding 353 are wound on a bobbin 502 (dotted lines) into which an EE16 ferrite core 501 extends. The auxiliary winding 351 is wound on the bobbin 502 on the primary side as shown in FIG. 23A, and the main winding 352 is wound over the auxiliary winding 351 as shown in FIG. 23B.

The auxiliary winding 351 has a start end 503 and a finish end 504, the main winding 352 has a start end 505 and a finish end 506. The secondary winding 353 has a start end 507 and a finish end 508.

An EE core is formed of a pair of E cores assembled together with a spacer gap SGa of 0.4 mm defined between the E cores.

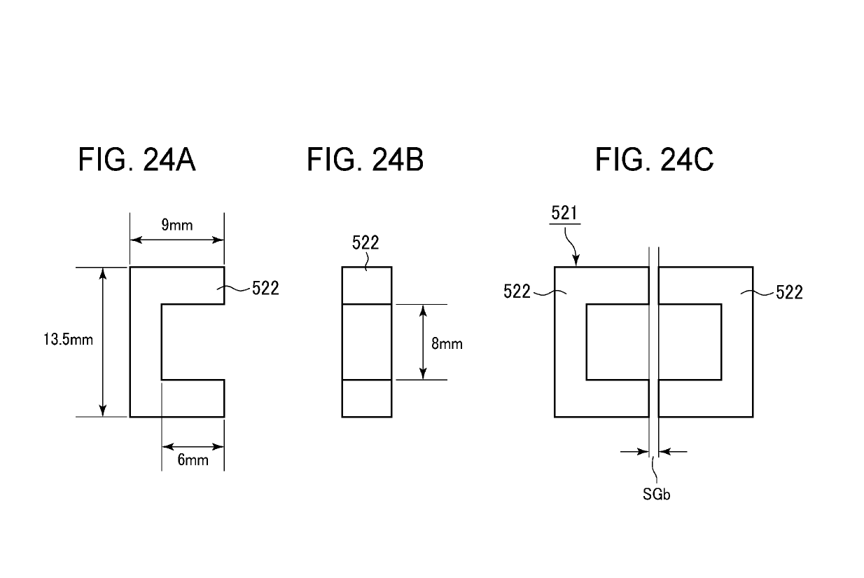

FIGS. 24A-24C illustrate a core used for the step-up transformer 450. The step-up transformer 450 of the positive bias generator 280 employs a UU ferrite core 521 as shown in FIG. 24C, in which cores 522 shown in FIGS. 24A and 24B are assembled together. It is to be noted that a gap SGb of 0.8 mm is formed between the two E cores.

### {Operation of Negative Bias Generator}

Referring back to FIG. 3, the print engine controller 220 outputs a command to specify the target high-voltage output through the SCI port 220a. The command is received at the SCI port 260a of the microcomputer 260. Referring to FIGS. 21 and 20, when neither the positive high-voltage output nor the negative high-voltage output is to be outputted to the node 390C, the print engine controller 220 outputs a command to set the target high-voltage output to 0 v. In response to the command, the microcomputer 260 outputs the PWMn signal having a duty cycle of 100% from the PWMn port 260n and the PWMp signal having a duty cycle of 0% from the PWMp port 260p (FIG. 20).

The PWMn port 260n is connected to the 3.3 V power supply 302 through a resistor 305. When the PWMn signal outputted from the PWMn port 260n is the High level, the potential of the PWMn port 260n is pulled up to 3.3 V. The 3.3 V at the PWMn port 260n is fed as the reference voltage through the filter circuit 310 to the inverting input (−) of the OP amp 321.

The 3.3 V output voltage of the power supply 303 is divided by the 3.6 kΩ resistor 372 and the 100 kΩ resistor 373. When the high-voltage output is not to be outputted on the node 390C, the voltage across the 100 kΩ resistor 373 is 3.2 V, and is fed as a feedback voltage to the non-inverting input (+) of the OP amp 321. The feedback voltage reflects the voltage of the high-voltage output. Since the feedback voltage fed to the non-inverting input (+) is lower than the reference voltage fed to the inverting input, the high-voltage output VO of the OP amp 321 is lowest (VOL=0 V).

With this condition, the gate voltage of the FET 340 is sufficiently lower than the gate threshold voltage VTH, and therefore the FET 340 remains turned off. As a result, no current flows through the windings of the step-up transformer 350 and the output on the node 390C remains off.

The positive bias generator 280 operates in a similar way to the negative bias generator 270, so that the high-voltage output does not appear on the node 490C. In other words, the voltage of 0 V at the PWMp port 260p is fed as a reference voltage to the non-inverting input (+) of the OP amp 421 through the filter circuit 410. The 3.3 V outputted from the power supply 302 is divided by the 1 MΩ resistor 472 and the 51 kΩ resistor 473. When the high-voltage output is not to be outputted on the node 490C, the voltage across the 51 kΩ resistor 473 is 0.16 V and is fed as the feedback voltage to the inverting input (−) of the OP amp 421. Since the reference voltage is lower than the feedback voltage, the output voltage VO of the OP amp 421 is lowest (VOL=0 V).

With this condition, the gate voltage of the FET 440 is sufficiently lower than the gate threshold voltage VTH, and therefore the FET 440 remains off. As a result, no current flows through the respective windings of the step-up transformer 450 and the output on the node 490C remains off.

When the image forming apparatus starts to print an image, the belt motor 256 starts to run. The print engine controller 220 sends a command to the microcomputer 260 by serial communication, specifying the target high-voltage output to be supplied to the secondary transfer roller 156.

The target negative high-voltage output applied to the secondary transfer roller 156 is, for example, −3000 V. Assume that the duty cycle of the PWMn signal corresponding to the target high-voltage output of −3000 V is 0%. Thus, the print engine controller 220 sends a command to specify the target high-voltage output of −3000 V to the microcomputer 260.

In response to the command from the print engine controller 220, the microcomputer 260 switches the duty cycle of the PWMn signal at the PWMn port 260n to 0%, which corresponds to the target high-voltage output of −3000 V.

The PWMn signal corresponding to the target high-voltage output of −3000 V is smoothed out by the filter circuit 310 into a DC voltage corresponding to the target high-voltage output, and is then input to the integrator 320.

The OP amp 321, capacitor 322, and resistor 323 constitute the integrator 320 having a time constant given by the capacitor 322 and resistor 323. When the high-voltage output is to be off, the integrator 320 outputs a voltage of 0 V (VOL). The filter circuit 310 receives the PWMn signal corresponding to the target high-voltage output from the microcomputer 260, and outputs a DC voltage, i.e., the reference voltage, to the inverting input of the OP amp 321. The voltage, e.g., 0.3 V at the inverting input is lower than the feedback voltage (=3.2 V) at the non-inverting input of the OP amp 321, and the output of the integrator 320 gradually increases due to the time constant given by the capacitor 322 and the resistor 323.

The output of the integrator 320 increases gradually, and is fed to the differentiator 330. The output of the differentiator 330 is then fed to the gate of the FET 340. This implies that the output voltage of the integrator 320 is divided by the resistors 324, 326, 331, and 333 and the divided voltage is fed to the gate of the FET 340.

When the output of the differentiator 330 increases above the gate threshold voltage VTH of the FET 340, the FET 340 becomes on, causing current to flow through the main winding 352 of the step-up transformer 350 so that oscillation starts with the frequency determined by the capacitor 345, the inductance of the main winding 352, the mutual inductance of the main winding 352, auxiliary winding 351, secondary winding 353, and parasitic capacitances. The AC voltage appears across the auxiliary winding 351 due to the oscillation, and is fed to the gate of the FET 340 through the differentiator 330. The voltage fed to the gate causes the FET 340 to alternate between the ON state and the OFF state.

The Zener diode 336 conducts at a breakdown voltage higher than 12 V, so that the voltage across the Zener diode 336 will not exceed 12 V. The voltage across the Zener diode 336 is divided by the resistors 331 and 333. Thus, the voltage fed to the gate of the FET 340 is equal to or lower than 6 V.

The AC voltage across the secondary winding 353 of the step-up transformer 350 is rectified by the rectifying circuit 360, and the rectified voltage is stepped down by the output voltage converter 370 before being fed back to the integrator 320. As the absolute value of the negative high-voltage output increases, the feedback voltage gradually decreases below 3.3 V. When the negative high-voltage output reaches −3000 V which is the target voltage, the feedback voltage is zero volts. As the absolute value of the negative high-voltage output increases further, the feedback voltage becomes negative.

The integrator 320 compares the reference voltage corresponding to target high-voltage output with the feedback voltage. If the feedback voltage is higher than the reference voltage of 0.3 V, the output of the OP amp 321 increases, causing the gate voltage of the FET 340 to increase, hence the drain current of the FET 340 increases. Conversely, if the feedback voltage is lower than the reference voltage of 0.3 V, the output of the OP amp 321 decreases, causing the gate voltage of the FET 340 to decrease, hence the drain current of the FET 340 decreases. In this manner, the negative bias generator 270 performs feedback-control so that the feedback voltage is equal to the reference voltage.

The rectifying circuit 360 supplies the negative high-voltage output to the secondary transfer roller 156 through the resistor 477. As described above, the reference voltage is selected such that when the output of the rectifying circuit 366 is equal to the target high-voltage output, the reference voltage is equal to the feedback voltage. Thus, the voltage at the node 490C, supplied to the secondary transfer roller 156, may be maintained equal to the target high-voltage output.

Applying the negative high-voltage output to the secondary transfer roller 156 prevents the secondary transfer roller 156 from being contaminated by the residual toner on the intermediate transfer belt 141.

When the print paper 150 arrives at the nip 156N, the print engine controller 220 sends a command to the microcomputer 260 via serial communication, specifying the target high-voltage output so that the negative bias generator 270 is turned off and then the positive bias generator 280 is turned on.

### {Operation of Positive Bias Generator}

Referring to FIGS. 20 and 22, assume that the target positive high-voltage output is +2000 V and the corresponding duty cycle of the PWMp signal is 33.2%. In this case, the print engine controller 220 sends a command to the microcomputer 260, specifying the target high-voltage output of +2000 V.

In response to the command, the microcomputer 260 outputs the PWMp signal having a value corresponding to the target high-voltage output (+2000 V), i.e., 33.2% from the PWMp port 260p.

This PWMp signal is smoothed out by the filter circuit 410 into a DC voltage or reference voltage, which corresponds to the target high-voltage output. The reference voltage is then input to the integrator 420.

The OP amp 421, capacitor 422, and resistor 423 constitute the integrator 420 having a time constant determined by the capacitor 422 and resistor 423. As described above, the integrator 420 initially outputs the output voltage VOL, which is substantially 0 V, corresponding to the OFF state of the positive high-voltage output. Once the microcomputer 260 outputs the PWMp signal corresponding to the target high-voltage output and the filter circuit 410 feeds the DC voltage or reference voltage to the inverting input (−), the reference voltage (about 1.13 V) is higher than the voltage at the non-inverting input (+) and therefore the output of the filter circuit 460 gradually increases due to the time constant determined by the capacitor 422 and resistor 423.

The increase in the output voltage VO of the integrator 420 causes an increase in the input voltage of the differentiator circuit 430. The output voltage of the integrator 420 is divided by the resistors 424, 426, 431, and 433 before being fed to the gate of the FET 440.

When the DC voltage fed from the differentiator 430 increases above the gate threshold voltage VTH of the gate voltage, the FET 440 turns on. As a result, current flows through the main winding 451 of the step-up transformer 450, causing self-oscillation at a frequency determined by the self-inductance, the mutual inductance and stray capacitances of the primary winding and secondary windings of the step-up transformer 450, the capacitance of the rectifying circuit 360, and the current flowing into the secondary transfer roller 156. The AC voltage developed across the auxiliary winding 451 is fed to the gate of the FET 440 through the differentiator 430, causing the FET 440 to alternate between the ON state and the OFF state.

The Zener diode 436 has an anode connected to one end 451b of the auxiliary winding 451 and conducts when the voltage on the cathode exceeds 12 V. Thus, during the oscillation, the voltage divided by the resistors 431 and 433 is maintained equal to or lower than 6 V.

The AC voltage developed across the secondary winding 453 of the step-up transformer 450 is rectified by the rectifying circuit 460. The output of the rectifying circuit 460 is stepped down by the output voltage converter 470, and is fed back to the integrator 420. As the positive high-voltage output of the rectifying circuit 460 increases, the feedback voltage gradually increases from 0.15 V. When the high-voltage output at the node 490C reaches the target high-voltage output or +2000 V, the feedback voltage is 1.13 V. When the high-voltage output at the node 490C further increases, the feedback voltage increases even higher than 1.13 V.

The integrator 420 compares the reference voltage corresponding to the target high-voltage output with the feedback voltage. If the feedback voltage is lower than the reference voltage (=1.13 V), the output of the integrator 420 increases and therefore the gate voltage of the FET 440 also increases, causing the drain current to increase. If the feedback voltage is higher than the reference voltage (1.13 V), the output of the integrator 420 decreases and therefore the gate voltage VG of the FET 440 also decreases, causing the drain current of the FET 440 to decreases.

The positive high-voltage output outputted from the rectifying circuit 460 is supplied to the secondary transfer roller 156. As described above, the reference voltage is selected such that the reference voltage is equal to the feedback voltage when the output of the rectifying circuit 366 is equal to the target high-voltage output. Thus, the high-voltage output at the node 490C, supplied to the secondary transfer roller 156, may be maintained equal to the target high-voltage output.

By applying the positive high-voltage output to the secondary transfer roller 156, the toner image on the intermediate transfer belt 141 can be transferred onto the print paper 150.

When neither the negative high-voltage output nor the positive high-voltage output is to be outputted, the microcomputer 260 changes the duty cycle of the PWMn signal back to 100%, and the duty cycle of the PWMp signal back to 0%.

### {Waveforms of Various Parts}

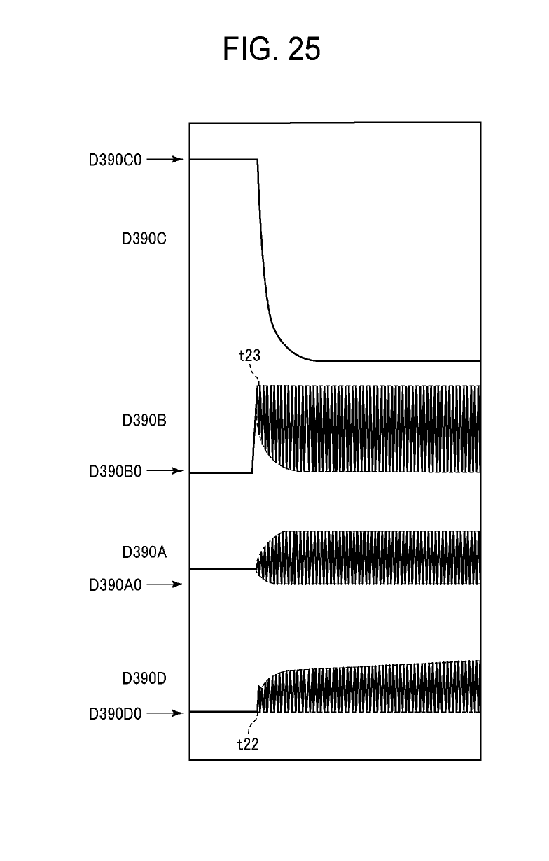

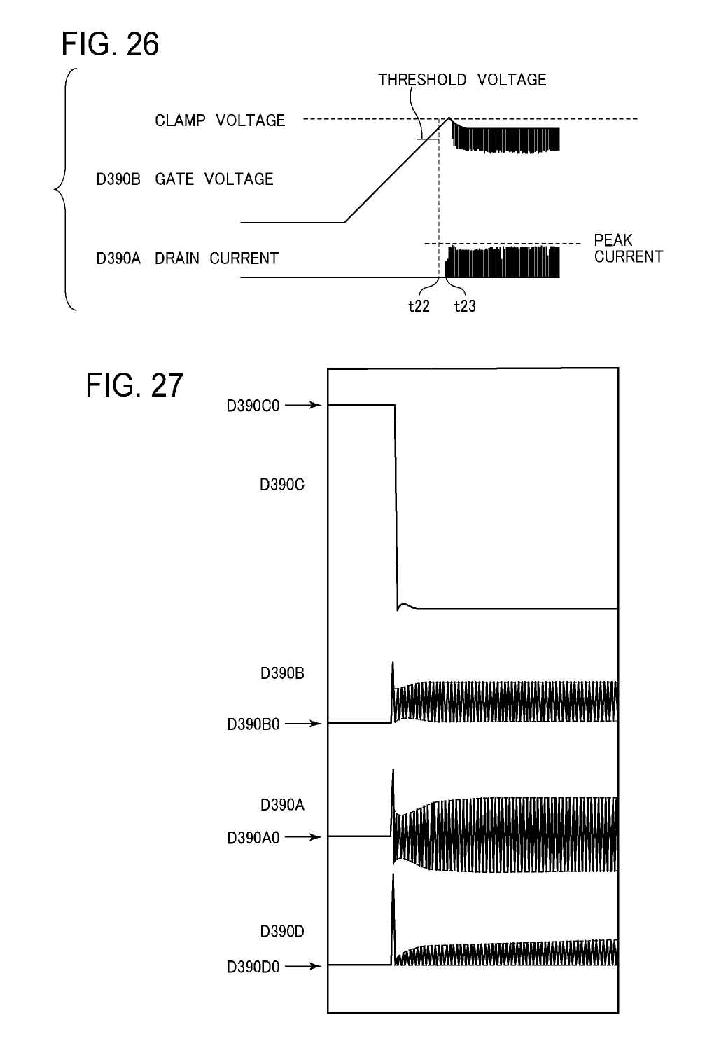

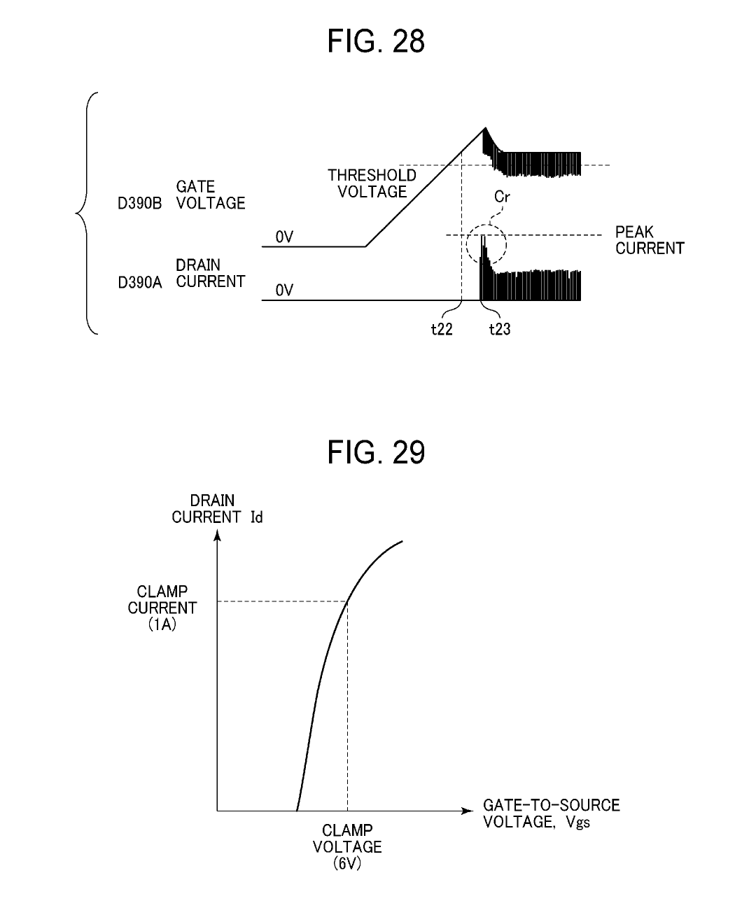

FIG. 25 illustrates the waveforms of the voltages and currents appearing at various parts of the circuit when the negative bias generator 270 shown in FIG. 21 outputs the high-voltage output. FIG. 26 illustrates the outline of the waveforms of the gate voltage D390B and drain current D390D shown in FIG. 25. FIG. 27 illustrates the waveforms, similar to those shown in FIG. 25, when the Zener diode is not inserted in the circuit shown in FIG. 21. FIG. 28 illustrates the outline of the waveforms of the gate voltage D390B and drain current D390D shown in FIG. 27. FIG. 29 illustrates the relationship between the gate-to-source voltage Vgs and drain current Id of the FET 340.

The reference character D390B shown in FIGS. 25 and 27 denotes the potential of the node 390B shown in FIG. 21 or the gate of the FET 340. The reference D390C denotes the potential of the node 390C or the output terminal of the rectifying circuit 360. The reference D390A denotes the current through the node 390A or the current through the main winding 352 of the step-up transformer 350. The reference D390D denotes the cathode of the Zener diode 336. The references D390A0, D390B0, D390C0, and D390D0 denote the zero levels of the waveforms D390A, D390B, D390C, and D390D, respectively.

Referring to FIGS. 27 and 28, the feedback voltage remains 3.2 V until the self-oscillation starts at time t22 and therefore the output of the OP amp 321 gradually increases, and hence the gate voltage D390B gradually increases. When the gate voltage VG reaches the gate threshold voltage VTH at time t22, current starts to flow through the FET 340. It is to be noted that there is some time from when the voltage appears across the secondary winding of the transformer 350 till the feedback voltage falls. Therefore, there is some delay time (times t22−t23) from when the gate voltage VG reaches the gate threshold voltage VTH of gate voltage till the output of the OP amp starts to decrease. FIG. 28 is an expanded view for illustration, illustrating the waveforms around times t22 and t23. The time delay causes the gate voltage to become higher than necessary, with the result that an excess rush current Cr as shown in FIG. 28 flows when the circuit starts to operate.

In the third embodiment, the Zener diode 336 is employed as shown in FIG. 21, and the output voltage of the OP amp 321 is divided by the 56 kΩ resistors 331 and 333 so that the maximum gate voltage is clamped to 6 V. This circuit configuration prevents the gate voltage from exceeding the necessary value while ensuring the necessary drain current, e.g., 1 A, while. Thus, no excessive current will flow through the FET 340.

As a result, the drain current after the rush current period may be set large, and therefore the output of the step-up transformer may be increased. This operation allows the rectifying circuit 360 to output large current.

The resistances of the 56 kΩ resistors 331 and 333 may be selected to clamp the maximum gate voltage to a desired voltage. The relationship between the gate-to-source voltage Vgs and the drain current depends on the type and model of FET. The clamp voltage may be selected such that the drain current is optimum.

The FET 340 is implemented with RCX120N25, available from ROHM. The gate input capacitance of RCX120N25 is 1800 pF. The capacitance of the capacitor 332 was selected to be 2680 pF, which is about 1.5 times the gate input capacitance. The resistance of the resistors 331 and 333 was selected to be 56 kΩ so that the AC signal outputted from the auxiliary winding 351 is fed to the FET 340 and the gate voltage is feedback-controlled through the output of the OP amp 321. If the resistors 331 and 333 have too low a resistance, the power loss of the FET 340 increases and therefore the temperature of the FET 340 increases. From this point of view, the resistors 331 and 333 should have a resistance higher than 56 kΩ and lower than 200 kΩ.

The output of the integrator 320 causes the drain current of the FET 340 to increase until the feedback voltage is equal to the voltage (0.3 V) inputted to the inverting input (−) from the filter circuit 310. As a result, the high-voltage output increases in its absolute value until the high-voltage output is −3000 V, and then remains −3000 V.

The high-voltage output at the node 390C shown in FIG. 21 reaches −3000 V, which is then applied to the secondary transfer roller 156 through the 100 MΩ resistor 477 in the positive bias generator 280. Most of the output current, which is about 1 mA at −3000 V, flows through the 3 MΩ resistor 371 and the 3.6 kΩ resistor 372, and the current that flows into the secondary transfer roller 156 is less than 30 μA.

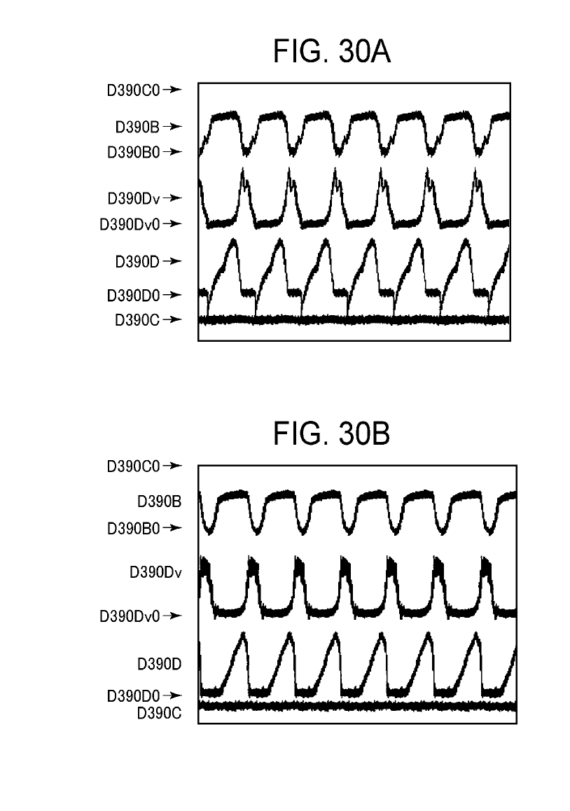

With reference to FIGS. 30B and 30B, a description will be given of why the capacitor 345 is connected across the source and the drain of the FET 340. FIGS. 30B and 30B illustrate the waveforms at various parts in the circuit when the high-voltage output of −3000 V is outputted. The reference D390B denotes the voltage at the gate of the FET 340, and the reference D390Dv denotes the potential of the drain of the FET 340. The reference D390D denotes the drain current, and the reference D390C denotes the negative high-voltage output at the node 390C. The reference D390D denotes the drain current through the node 390A, measured using a current probe. The voltage D390C at the node 390C was measured using a high voltage probe. The waveforms shown in FIGS. 25 and 27 were also observed in the same way.

FIG. 30A illustrates the waveforms at various points in the circuit when the 0.01 μF capacitor 345 is inserted into the circuit. FIG. 30B illustrates the comparison waveforms at various points in the circuit when the 0.01 μF capacitor 345 is not inserted into the circuit. Referring to FIG. 30A, the capacitor 345 causes the oscillation frequency to decrease from about 70 kHz to 64 kHz, and the peak drain current to decrease from 920 mA to 850 mA. This caused the surface temperature of the FET 340 to decrease by 10° C. The FET 340 was implemented with a TO-220 package field effect transistor and was used with a heat sink for heat dissipation.

The step-up transformer 350 is configured as shown in FIGS. 23A and 23B, using the EE ferrite core 501 that extend through the bobbin. The auxiliary winding 351 and the main winding 352 are wound one over the other on the bobbin. The bobbin on the secondary side is divided into four sections by partitions 513b, 513c, and 513d. The secondary windings has a total of 1200 turns, i.e., 300 turns in each section. A partition 513a is located between the primary side 511 and the secondary side 512. The self-oscillation frequency of the circuit was about 90 kHz when the high-voltage output was −500 V, and about 64 kHz when the high-voltage output is −3000 V. Most of the current supplied to the secondary transfer roller 156 flows through the 3 MΩ resistor 371. Therefore, the current flowing through the 100 MΩ resistor 477 is only a very small fraction of that flowing through the resistor 371.

The step-up transformer 450 is configured as shown in FIG. 24C, using a UU ferrite core 521. When the main winding 452 has 27 turns, the auxiliary winding 451 has 5 turns, the secondary winding has 2760 turns, a high-voltage output of 2 kV and a current of 1 mA were obtained for the secondary transfer roller 156. At this time, a current of 1 mA flows through the 3 MΩ resistor 371 and the anode potential of the diode 462 is −3 kV, which means that the stepped-up voltage of the step-up transformer 450 is 5 kV.

As described above, the self-oscillation circuit is primarily constituted of the FET and the step-up transformer. The differentiator drives the FET to control the drain current of the FET, thereby achieving the high-voltage output with a maximum power of about 3 W. The voltage clamping circuit 335 maintains the maximum gate voltage VG below a predetermined value, thereby limiting the rush current immediately after the apparatus is activated. The configuration is also effective in increasing the output of the step-up transformer. For example, the high-voltage output of −3000 V with a current of 1 mA can be achieved by using an open transformer (non-mold type transformer) formed of the EE16 ferrite.

As a result, the positive bias generator 280 is capable of outputting the positive high-voltage output with a maximum current of 1 mA, providing good transfer results when images are transferred onto a narrow width medium even in a high-temperature and high-humidity environment in which the electrical resistance of the secondary transfer roller used in an intermediate transfer image forming apparatus is low.

This implies that the positive bias generator 280 may be immune to the decrease of the resistance of the secondary transfer roller and therefore the fixing section may be located in the vicinity of the secondary transfer roller. Thus, a print medium having a narrow width may be transported with the shorter sides extending in directions parallel to the direction of travel of the print medium. For example, envelopes tend to wrinkle if they are transported through the fixing unit with the longer sides extending in the direction of travel of the print paper. This drawback may be overcome by the positive bias generator according to the third embodiment.

### Fourth Embodiment

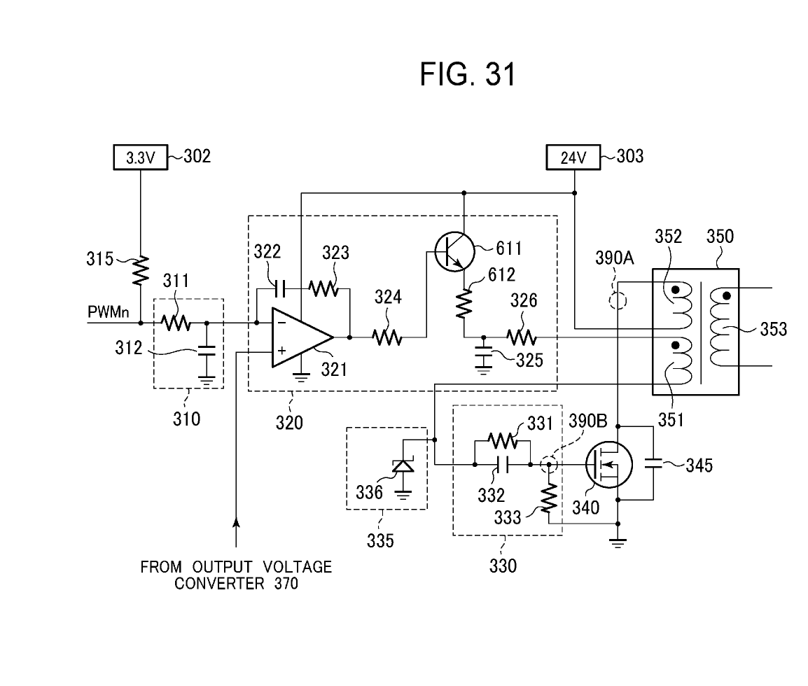

FIG. 31 illustrates a transformer driver circuit and a step-up transformer for a negative bias generator according to a fourth embodiment. The fourth embodiment is generally the same as the third embodiment except that an integrator 320 is employed. The integrator 320 includes an NPN transistor 611, and the output of the OP amp 321 is fed to the base of the transistor 611 through a resistor 324. The transistor 611 has a collector connected to a 24 V power supply 303 and an emitter connected to one end of the auxiliary winding 351 through a resistor 326 and a resistor 612.

The output of the OP amp 321 drives the base current of the NPN transistor 611 so that the emitter current of the transistor 611 flows through the auxiliary winding 351 into the resistors 331 and 333. The voltage across the resistor 333 is fed to the gate of the FET 340. Thus, when the feedback voltage is fed to the non-inverting input of the OP amp 321, the negative bias generator performs feedback control as a whole. The fourth operates in the same as the third embodiment except the above operation.

### Fifth Embodiment

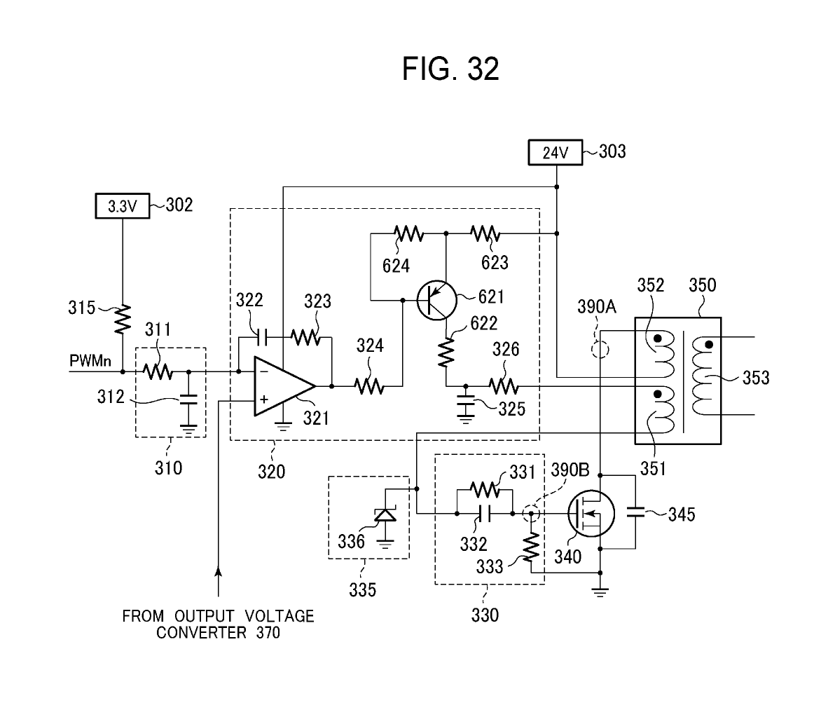

FIG. 32 illustrates a transformer driver and a step-up transformer for a negative bias generator according to a fifth embodiment. The fifth embodiment is generally the same as the third embodiment except that an integrator 320 is employed.

The fifth embodiment differs from the fourth embodiment in that the feedback voltage is fed to the inverting input of the OP amp 321, the reference voltage is fed to the non-inverting input, and a PNP transistor 621 is used.

The integrator 320 includes a PNP transistor 621 and the output of the OP amp 321 is fed to the base of the transistor 621 through a resistor 324. The transistor 621 has an emitter connected to a 24 V power supply 303 through a resistor 623 and a collector connected to one end of a resistor 622 through a resistor 622, and the other end of the resistor 326 is connected to one end of the auxiliary winding 351. The resistor 624 is connected across the base-emitter of the transistor 621.

The non-inverting input (+) of the OP amp 321 receives the output (reference voltage) of a filter circuit 310 while the inverting input (−) receives a feedback voltage from an output voltage converter 370. When the reference voltage is lower than the feedback voltage, the output of the OP amp 321 increases causing the base current of a PNP transistor 621 to decrease, hence decreasing the collector current of the transistor 621. The decrease in the collector current of the transistor 621 causes the gate voltage VG of the FET 340 to decrease. Conversely, when the reference voltage is higher than the feedback voltage, the output of the OP amp 321 decreases, causing the base current of the transistor 621 to increase, hence increasing the collector current of the transistor 621. The increase in the collector current of the transistor 621 causes the gate voltage VG of the FET 340 to increase.

In this manner, the output of the OP amp 321 controls the base current of the PNP transistor 621. The collector current of the PNP transistor 621 flows through the auxiliary winding 351 into the resistor 333, thereby feedback-controlling the gate voltage VG of the FET 340. The transistor 621 (PNP) shown in FIG. 32 has the opposite polarity to the transistor 611 (NPN) shown in FIG. 31, therefore the feedback voltage inputted to the inverting input of the OP amp 321 also has the opposite polarity. The fifth embodiment operates in the same as the third embodiment (FIG. 21) except the above operation.

### Sixth Embodiment

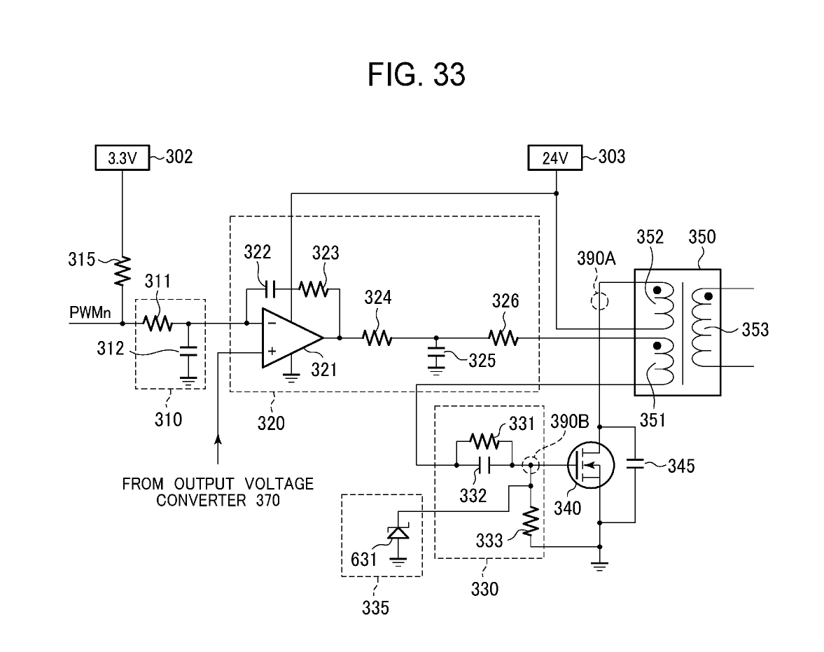

FIG. 33 illustrates a transformer driver circuit and a step-up transformer for a negative bias generator according to a sixth embodiment. The sixth embodiment is generally the same as the third embodiment except that a clamping circuit 335 is employed. A 6.2 V Zener diode 631 is connected between gate and source of the FET 340, i.e., in parallel with the resistor 333.

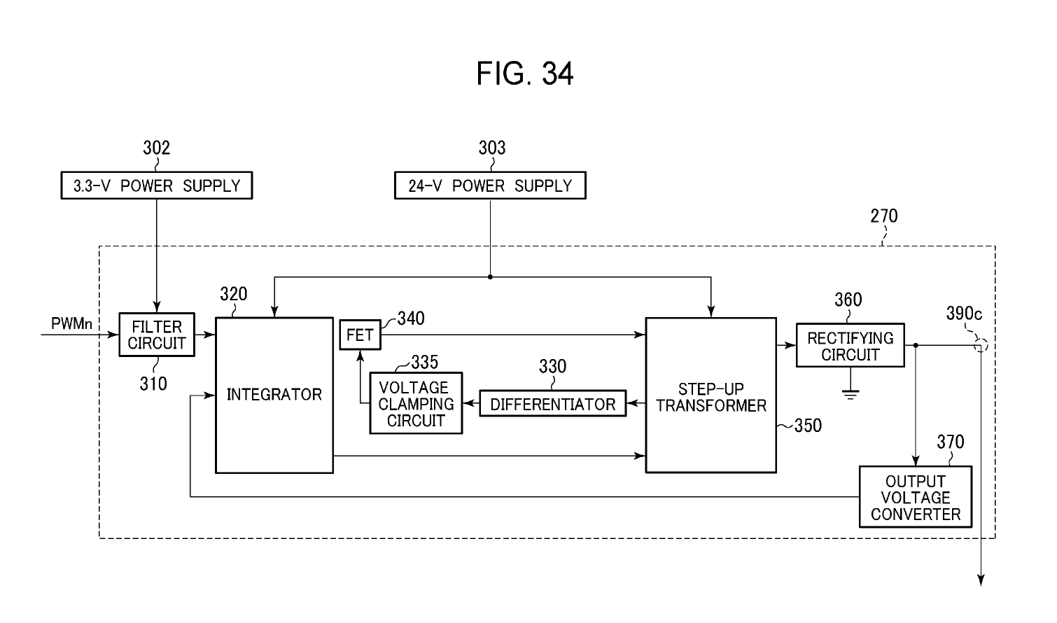

FIG. 34 is the block diagram of a negative bias generator 270, corresponding to FIG. 33, together with a 3.3 V power supply 302 and a 24 V DC power supply 303. In the sixth embodiment, feedback control is performed in the same as the third embodiment except the above operation.

### Seventh Embodiment

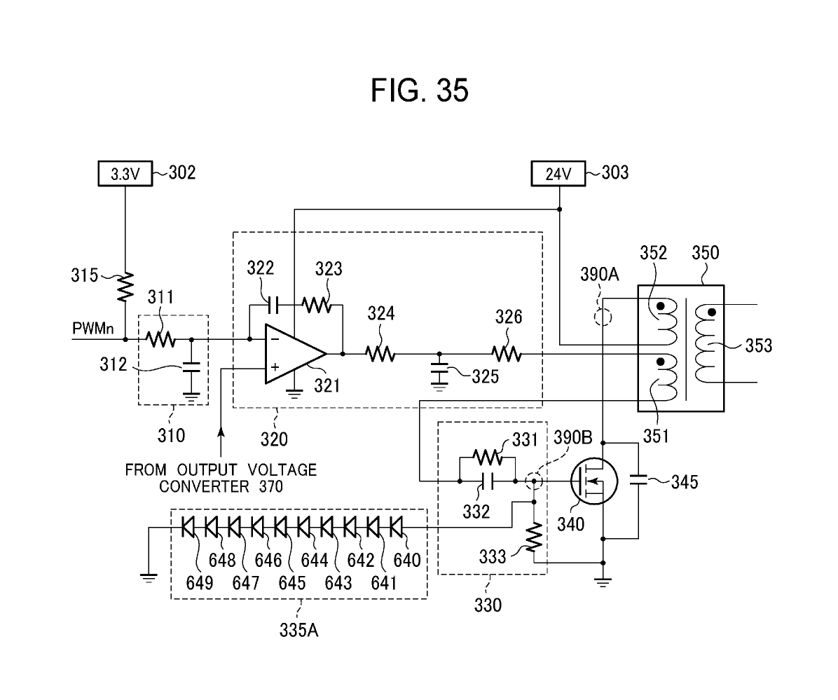

FIG. 35 illustrates a transformer driver circuit and a step-up transformer for a negative bias generator according to a seventh embodiment. The seventh embodiment is generally the same as the sixth embodiment except that a clamping circuit 335A is employed. A 6.2 V Zener diode 631 has a cathode connected to the gate of an FET 340 and an anode connected to the ground. The clamping circuit 335A includes a series circuit of a plurality of diodes 640-649. Each diode has a forward voltage Vf of 0.6 V so that the clamping circuit 335A maintains the voltage to a level equal to or lower than 6 V. Any number of diodes may be employed in accordance with the required clamp voltage.

The block diagram of the negative bias generator 270 shown in FIG. 35 is the same as that shown in FIG. 34 except that the clamping circuit 335A is connected across the gate and source of the FET 340.

The modifications shown in FIGS. 31-35 may also be applied to the transformer driver circuit for a positive bias generator 280. The second to seventh embodiments also provide the similar effects to the third embodiment.

### Eighth Embodiment

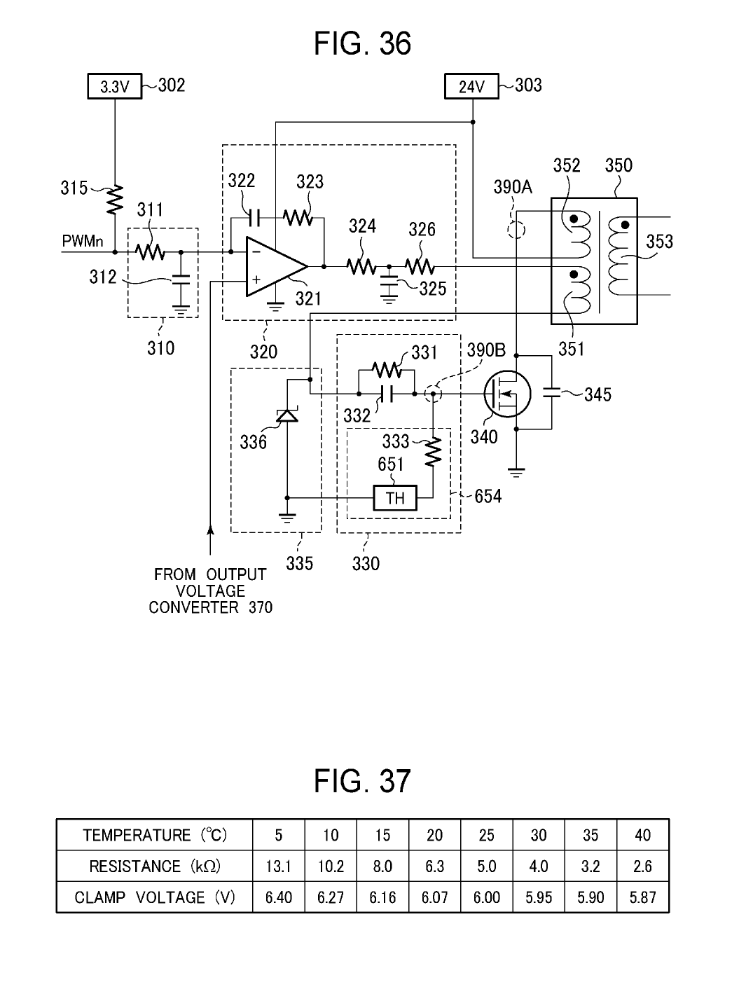

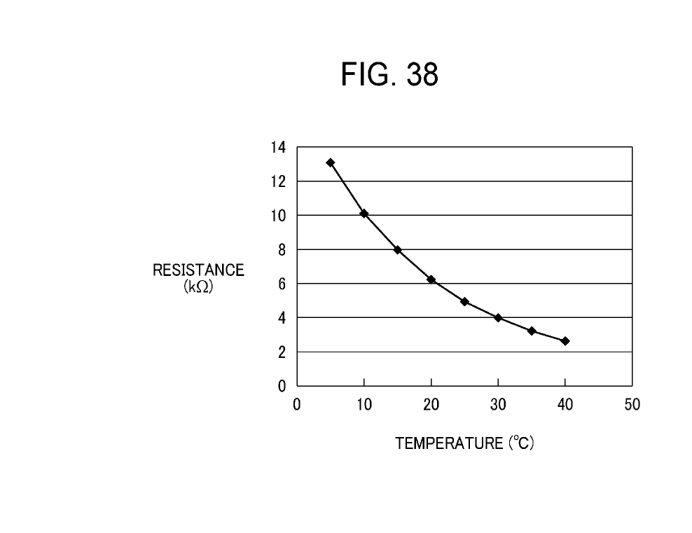

FIG. 36 illustrates a transformer driver circuit and a step-up transformer for a negative bias generator according to an eighth embodiment. The eighth embodiment is generally the same as the third embodiment except that a series circuit of a thermistor 651 and a 56 kΩ resistor 333 is connected between the gate of the FET 340 and the ground. FIG. 37 illustrates the relationship among temperature, resistance of thermistor, and clamp voltage. FIG. 38 is a graph illustrating the relationship between the resistance of the thermistor and temperature. The thermistor 651 is a negative temperature coefficient thermistor so that the electrical resistance of the thermistor 651 decreases with increasing temperature as shown in FIGS. 37 and 38. Referring to FIGS. 37 and 38, the resistance is 5 kΩ at a temperature of 25° C.

The thermistor 651 is employed to compensate for changes in the drain current of the FET 340 due to temperature changes. The thermistor 651 is disposed in the vicinity of the FET 340 to sense the temperature of the FET 340.

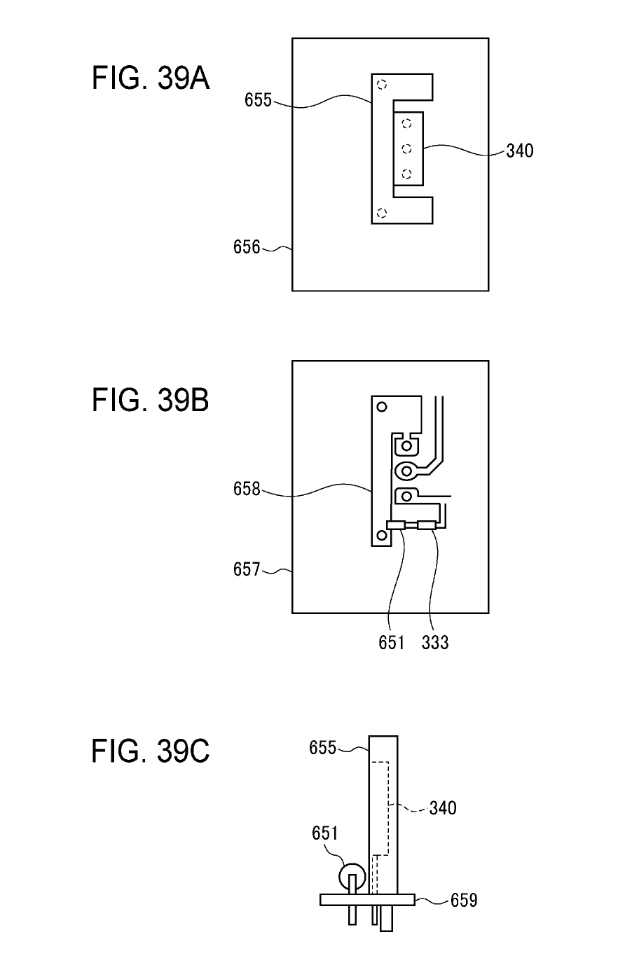

FIGS. 39A-39C illustrate examples of mounting location of thermistor. As shown in FIGS. 39A and 39B, if the thermistor 651 takes the form of a surface-mount component, the thermistor 651 has one end electrically connected to a ground trace 658. The ground trace 658 is formed on a solder side 657 of a circuit board and is thermally coupled to a heat sink 655 mounted on a component side of the circuit board. Thus, the thermistor 651 receives the heat generated by the FET 340.

As shown in FIG. 39C, if the thermistor 651 takes the form of a lead component, the thermistor 651 is disposed in the vicinity of the heat sink 655.

In the third embodiment, the zener voltage across the zener diode 336 is divided by the 56 kΩ resistors 331 and 333 to obtain a clamp voltage of 6 V. In the eighth embodiment, the zener voltage of 12 V of the Zener diode 336 is divided by a dividing circuit 654 formed of the 56 kΩ resistor 331, 51 kΩ resistor 331, and thermistor 651 (5 kΩ at 25° C.), thereby clamping the gate voltage VG of the FET 340 to 6 V at 25° C. The clamp voltage increases with decreasing temperature as shown in FIG. 37.

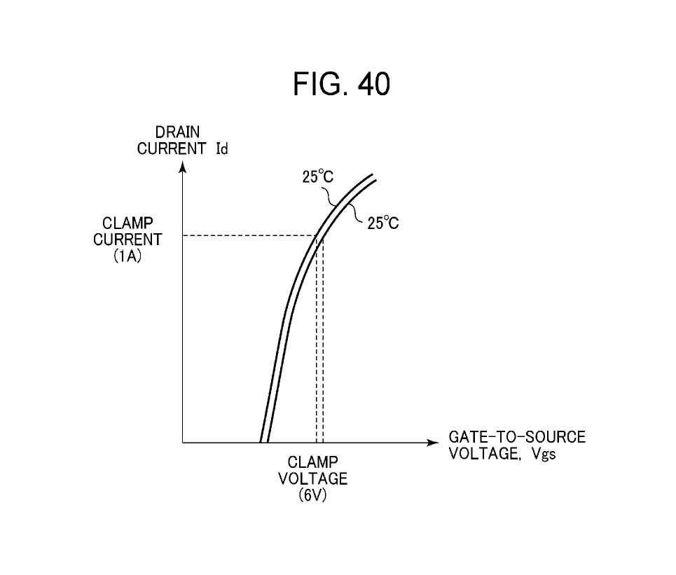

FIG. 40 illustrates the relationship between the gate-to-source voltage Vgs and the drain current Id of the FET 340. The drain current decreases with decreasing temperature. The resistance of the thermistor increases at low temperature, so that the clamped gate voltage VG is higher at low temperature and therefore the drain current increased at low temperature. When the FET operates, the temperature of FET increases and the thermistor operates to decrease the gate voltage VG of the FET 340, thereby preventing excess drain current of the FET 340.

The eighth embodiment also provides the same effects as the third embodiment. The eighth embodiment provides a maximum output of negative high-voltage output when the negative bias generator is activated at a temperature not higher than 10° C., and prevents the drain current of the FET 340 from increasing excessively. Also, the eighth embodiment provides a maximum negative high-voltage output even when the negative bias generator is activated at low temperatures below 0° C., and prevents excessive current from flowing through the FET at high temperatures. As a result, the negative bias generator can operate over a wide temperature range.

Instead of connecting a series circuit of the resistor 333 and negative coefficient thermistor 651 between the ground and the gate of the FET 340, a series circuit of the resistor 333 and a positive temperature coefficient thermistor may be connected between the gate of the FET 340 and one end of the auxiliary winding 351, and the resistor 333 may be connected between the gate and the ground. Further, a series circuit of the positive temperature coefficient thermistor and the resistor 331 may be connected between the gate of the FET 340 and the end of the auxiliary winding 351, and a series circuit of the resistor 333 and the negative temperature coefficient thermistor 651 may be connected between the ground and the gate of the FET 340.

In a generalized form, a first resistor circuit may be connected between one end of the auxiliary winding 351 and the gate of the FET 340, and a second resistor circuit may be connected between the gate and the ground, so that the voltage is divided by the first and second resistor circuits before the divided voltage is applied to the gate. For example, another way of looking at the circuit shown in FIG. 21 is that it is configured such that the first resistor circuit is formed only of the resistor 331.

The fourth and fifth embodiments are modifications to the third embodiment, and may also be applicable to the eighth embodiment. While the second to eighth embodiments have been described in terms of the transformer driver circuit as a modification to the negative bias generator of the third embodiment, a similar modification may also be made to the transformer driver circuit of the negative bias generator.

The high-voltage output power supply has been described in terms of a power supply that provides a negative bias applied to the secondary roller when the print medium is not present at the second transfer nip. The high-voltage output power supply may also be used in cleaning the secondary transfer roller on which the residual toner remains, in which case the positive bias and the negative bias may be applied alternately every one complete rotation of the secondary transfer roller 156 after completion of the secondary transfer operation, thereby transferring the toner on the secondary transfer roller 156 back to the transfer belt 141. When the toner is transferred back to the transfer belt 144, the secondary transfer voltage generating section 264 operates in the same way as described in the third to eighth embodiments.

While the high-voltage output power supply has been described with respect to a color intermediate transfer image forming apparatus, the present invention may also be applied to a color image forming apparatus or a monochrome image forming apparatus of the direct transfer system.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A high-voltage power supply comprising:
a transformer including a main winding with a first end connected to a DC power supply and a second end, an auxiliary winding with a third end and a fourth end, and a secondary winging that steps up a voltage developed across the main winding;
a rectifier that rectifies the stepped up voltage into a high-voltage output;
a voltage converter that produces a feedback signal from the high-voltage output, the feedback signal reflecting the high-voltage output;
a field effect transistor including a drain connected to the second end, a gate, and a source connected to the ground through one of a first resistor and a direct connection;
a differentiator including a parallel circuit of a second resistor and a capacitor, and a third resistor connected between a fifth end of the parallel circuit and the ground, the fifth end being connected to the gate of the field effect transistor, the sixth end being connected to the fourth end of the auxiliary winding so that a voltage appearing across the auxiliary winding is fed through the capacitor to the gate of the field effect transistor, causing self-oscillation;
an integrator including an operational amplifier with a first input terminal to which a reference signal indicative of a target high-voltage output is inputted, a second input terminal to which the feedback signal is inputted, and an output terminal, the integrator integrating the difference between the reference signal and the feedback signal and feeding the integrated output to the third end from the output terminal, so that negative feedback is performed to maintain the high-voltage output to the target high-voltage output.

2. The high-voltage power supply according to claim 1, further comprising a D/A converter that produces the reference signal in the form of an analog voltage signal in accordance with digital data that describes the target high-voltage output.

3. The high-voltage power supply according to claim 1, further comprising a filter circuit that smoothes a pulse width modulation signal having a duty cycle corresponding to the target high-voltage output and outputs the smoothed signal as the setting signal.

4. The high-voltage power supply according to claim 1, wherein the first resistor is an overcurrent protection resistor.

5. The high-voltage power supply according to claim 1, wherein the source is directly connected to the ground.

6. The high-voltage power supply according to claim 1, wherein the capacitor has a capacitance in the range of ½ to 3/2 of a gate input capacitance of the field effect transistor, and the second resistor and the third resistor have resistances in the range of 30 to 150 kΩ.

7. The high-voltage power supply according to claim 1, wherein the following relationship is satisfied:
GTH>VOH×(R2/(R1+R2))
where GTH is a gate threshold voltage of the field effect transistor, R1 is a resultant resistance in series between the output of the integrator and the gate of the field effect transistor, R2 is a resistance between the gate of the field effect transistor and the ground, and a maximum output voltage of the integrator.

8. The high-voltage power supply according to claim 1, wherein the reference signal initially has a value indicative of an absolute value of the high-voltage output large than that of the target high-voltage output from when the high-voltage power supply starts to output the high-voltage output until immediately before the field effect transistor turns on, and has a value indicative of an absolute value of the target high-voltage output immediately before the field effect transistor turns on.

9. The high-voltage power supply according to claim 8, wherein the high-voltage output having the absolute value larger than that of the target high-voltage output is a high-voltage output having largest absolute value.

10. An image forming apparatus incorporating the high-voltage power supply according to claim 1, wherein the image forming apparatus comprises a controller that supplies one of the pulse width modulation signal and digital data, the pulse width modulation signal having a duty cycle corresponding to the target high-voltage output and the digital data describing the target high-voltage output to the high-voltage power supply.

11. The high-voltage power supply according to claim 1, further comprising a voltage clamping circuit that prevents the voltage applied to the gate of the field effect transistor from exceeding a certain voltage.

12. The high-voltage power supply according to claim 1, wherein the voltage clamping circuit includes a Zener diode connected between the ground and the fourth end of the auxiliary winding, and the voltage across the Zener diode is divided down by the second resistor and the third resistor.

13. The high-voltage power supply according to claim 1, wherein the voltage clamping circuit includes a Zener diode connected between the gate of the field effect transistor and the ground so that the voltage applied to the gate is equal to or lower than the Zener voltage.

14. The high-voltage power supply according to claim 11, wherein the clamping circuit includes one or more diodes series-connected in one direction so that the voltage applied to the gate of the field effect transistor is equal to or lower than a sum of a forward voltage drop of respective diode.

15. The high-voltage power supply according to claim 1, wherein the third resistor is a series circuit of a resistor and a thermistor, the thermistor having a negative temperature coefficient so that an input signal to the is divided in magnitude by the second and third resistors and the divided down signal varies in magnitude with temperature.

16. The high-voltage power supply according to claim 15, wherein the thermistor is disposed in a position relative to the field effect transistor so that the thermistor senses the temperature of the field effect transistor.

17. The high-voltage power supply according to claim 1, wherein the capacitor is a first capacitor, wherein the high-voltage power supply further comprises a second capacitor connected between the drain and the source of the field effect transistor, the second capacitor adjusts a frequency of the self-oscillation.

18. The high-voltage power supply according to claim 1, wherein the high-voltage output is a negative voltage.

19. The high-voltage power supply according to claim 1, wherein the high-voltage output is a positive voltage.

20. A high-voltage power supply device incorporating a first high-voltage power supply and a second high-voltage power supply each according to claim 1, wherein in the first high voltage power supply, the high-voltage output is a negative voltage and in the second high voltage supply, the high voltage output is a positive voltage;
wherein the rectifying circuit of the second high-voltage power supply includes a positive output terminal and a negative output terminal, and a fourth resistor is connected between a positive output terminal of the second high-voltage power supply and a negative output terminal of the first high-voltage power supply;
wherein the high-voltage output of the first high-voltage power supply is supplied to a load through the fourth resistor.
